(19) United States
(12) Patent Application Publication
(10) Pub. No.: US 2009/0092716 A1
(43) Pub. Date: Apr. 9, 2009

(54) Gluten-free baked products and methods of preparation of same

(75) Inventors: William Alan Atwell, Champlin, MN (US); Jodi A. Engleson, Minneapolis, MN (US); Allen Richard Muroski, Bartlett, TN (US); Sean McIlwain Finnie, Manhattan, KS (US); Sean Acie Smith, Minneapolis, MN (US)

Correspondence Address: CARGILL, INCORPORATED, LAW/24, 15407 MCGINTY ROAD WEST, WAYZATA, MN, 55391, US

(73) Assignee: CARGILL, INCORPORATED, Wayzata, MN (US)

(21) Appl. No.: 12/218,153

(22) Filed: Jul. 11, 2008

Related U.S. Application Data
(60) Provisional application No. 60/949,482, filed on Jul. 12, 2007.

(51) Int. Cl. A21D 13/00; A23L 1/29

(52) U.S. Cl. 426/233; 426/550

(57) ABSTRACT

The present invention provides an ingredient delivery system and methods of producing a gluten-free bakery product using an oven to produce quality gluten-free bakery products made by this method.

This application claims priority to U.S. Provisional Patent Application No. 60/949,482, filed Jul. 12, 2007, the entirety of which is incorporated herein by reference.

Gluten is a protein complex found in the triticeae tribe of grains, which includes wheat, barley and rye. The gluten content in wheat flour provides desirable organoleptic properties, such as texture and taste, to innumerable bakery and other food products. Gluten also provides the processing qualities familiar to both the home baker as well as the commercial food manufacturer. In short, gluten is considered by many to be the “heart and soul” of bakery and other food products.

However, gluten has its drawbacks. The gluten protein complex, upon entering the digestive tract, breaks down into peptide chains like other protein sources, but the resulting gluten-related peptide chain length is longer than for other proteins. For this and other reasons, in some people, these longer peptides trigger an immune response commonly referred to as celiac disease. Celiac disease is characterized by inflammation, villous atrophy and crypt hyperplasia in the intestine. The mucosa of the proximal small intestine is damaged by an immune response to gluten peptides that are resistant to digestive enzymes. This damage interferes with the body's ability to absorb vital nutrients such as proteins, carbohydrates, fat, vitamins, minerals, and in some cases, even water and bile salts. If left untreated, celiac disease increases the risk of other disorders, such as anemia, osteoporosis, short stature, infertility and neurological problems, and has been associated with increased rates of cancer and other autoimmune disorders.

The early diagnosis of celiac disease, followed by treatment of celiac disease by eliminating gluten from the diet leads to clinical and histologic improvement, thereby helping to reduce the probability that some of the associated, irreversible disorders will occur in a person diagnosed with celiac disease. A gluten-free diet is the mainstay of safe and effective treatment of celiac disease.

There are other medical reasons for following a gluten-free diet. People who are gluten-intolerant or gluten sensitive, which may include people diagnosed with Crohn's disease, ulcerative colitis, irritable bowel syndrome, dermatitis herpetiformis, or autism, are sometimes recommended or prescribed to follow a gluten-free diet. In addition, some people experience an IgE-mediated response or allergy to wheat protein. The prevalence of gluten as a potential allergen has resulted in the U.S. Food and Drug Administration being required to issue regulations regarding the definition and requirements in order for a product to be labeled “gluten-free” by 2008. Europe and Canada have regulations currently in effect which define “gluten-free” labeling for food products. Therefore, there is also a compelling need for a diet that would meet regulatory bodies' definitions of a “gluten-free” label.

### SUMMARY OF THE INVENTION

The present invention provides an ingredient delivery system comprising a dry, gluten-free baking mix that when processed to form a batter and baked in an oven forms a bakery product has a peak viscosity of 34 cP to 4200 cP, and a 2nd minimum viscosity of 34 cP to 4789 cP. The term “gluten-free” is defined herein to mean that a food bearing this claim in its labeling does not contain any one of the following:

An ingredient that is a prohibited grain.

An ingredient that is derived from a prohibited grain and that has not been processed to remove gluten.

An ingredient that is derived from a prohibited grain and that has been processed to remove gluten, if the use of that ingredient results in the presence of 20 parts per million (ppm) or more gluten in the food or

20 ppm or more gluten.

The term “prohibited grain” is defined herein to mean any one of the following grains:

Wheat, meaning any species belonging to the genus Triticum

Rye, meaning any species belonging to the genus Secale

Barley, meaning any species belonging to the genus Hordeum

Crossbred hybrids of wheat, rye or barley (e.g., triticale, which is a cross between wheat and rye)

In certain embodiments, the bakery product further has a minimum viscosity of 33 cP to 263 cP. In certain embodiments, the bakery product further has a minimum viscosity range of 14° C. to 60° C. In certain embodiments, the bakery product further has a temperature at minimum viscosity of 24° C. to 96° C. In certain embodiments, the bakery product further has a temperature at peak viscosity of 77° C. to 101° C. In certain embodiments, the bakery product further has a temperature at second minimum viscosity of 90° C. to 105° C. In certain embodiments, the bakery product further has an absolute solubility of 37° C. to 41° C. In certain embodiments, the bakery product further has an absolute gelatinization of 67° C. to 91° C. In certain embodiments, the bakery product further has an absolute set-back of 103° C. to 129° C. In certain embodiments, the bakery product further has a set-back rate of −340 cP/° C. to −20 cP/° C. In certain embodiments, the bakery product further has a gelatinization rate of 130 cP/° C. to 570 cP/° C. In certain embodiments, the bakery product further has a solubility rate of −240 cP/° C. to −60 cP/° C.

In certain embodiments, the bakery product is a cake, muffin, pancake or waffle. In certain embodiments, the bakery product is wheat-free. As used herein the term “wheat-free” means that the food bearing this claim does not contain wheat or any species belonging to the genus Triticum. In certain embodiments, the bakery product is dairy-free. As used herein, the term “dairy-free” and “milk-free” mean that the food does not contain milk or milk-derived ingredients that can cause milk allergy, milk protein allergy, or lactose intolerance.

In certain embodiments, the bakery product is milk-free.

The present invention provides a method of producing a gluten-free bakery product comprising processing an ingredient delivery system comprising a dry, gluten-free baking mix to form a batter and baking the batter in an oven to form a bakery product has a peak viscosity of 34 cP to 4200 cP, and a 2nd minimum viscosity of 34 cP to 4789 cP. In certain embodiments, the oven that is used is an electrical resistance oven (ERO).

The present invention provides a gluten-free cake made by baking a gluten-free batter in an electrical resistance oven (ERO) such that the bakery product has a peak viscosity of 34 cP to 4200 cP, and a 2^{nd} minimum viscosity of 34 cP to 4780 cP.

The present invention provides method of monitoring quality of a bakery product comprising baking a gluten-free batter in an electrical resistance oven (ERO), measuring the peak viscosity and 2^{nd} minimum viscosity of the bakery product to determine if the bakery product has a peak viscosity of 34 cP to 4200 cP, and a 2^{nd} minimum viscosity of 34 cP to 4780 cP.

The present invention provides a method for making a gluten-free product, which involves the steps of: (a) combining gluten-free ingredients to make a gluten-free test batter; (b) performing an electrical resistance evaluation of the gluten-free test batter comprising identification of an acceptable minimum viscosity; (c) preparing a second gluten-free batter, wherein levels of the gluten-free ingredients are optimized based on the electrical resistance evaluation; and (d) heating the second gluten-free batter to prepare the gluten-free product.

The present invention provides product made by (a) combining gluten-free ingredients to make a gluten-free test batter; (b) performing an electrical resistance evaluation of the gluten-free test batter comprising identification of an acceptable minimum viscosity; (c) preparing a second gluten-free batter, wherein levels of the gluten-free ingredients are optimized based on the electrical resistance evaluation; and (d) heating the second gluten-free batter to prepare the gluten-free product.

### BRIEF DESCRIPTION OF THE FIGURES

FIG. 1. ERO curve of batter described in AACC 10-90, 270 ml water, 50% variac setting.

FIG. 2. Gluten free yellow cake ERO curve, 26% liquids.

FIG. 3 Gluten free yellow cake, 28% liquids.

FIG. 4. Gluten free yellow cake ERO curve, 28% liquids.

FIG. 5. Gluten free yellow cake ERO curve, 28% liquids.

FIG. 6. Gluten free yellow cake ERO curve, 31% liquids.

FIG. 7. A typical Texture Profile Analysis (TPA) curve.

FIG. 8. Electrical resistance oven profile showing the parameter origins.

FIG. 9. Minimum viscosity temperature range in relation to cake volume.

FIG. 10. Temperature at minimum viscosity in relation to 24 hour springiness.

FIG. 11. Absolute solubility in relation to 24 hour cohesiveness.

FIG. 12. Second minimum viscosity in relation to cohesiveness.

FIG. 13. Second minimum viscosity in relation to 24 hour cohesiveness.

FIG. 14. Temperature at second minimum viscosity in relation to hardness.

FIG. 15. Absolute gelatinization in relation to 24 hour cohesiveness.

FIG. 16. Absolute solubility in relation to cohesiveness.

FIG. 17. Absolute gelatinization in relation to cohesiveness.

FIG. 18. Absolute gelatinization in relation to resilience.

FIG. 19. Second minimum viscosity in relation to resilience.

FIG. 20. Temperature at peak viscosity in relation to 24 hour resilience.

FIG. 21. Second minimum viscosity in relation to 24 hour resilience.

FIG. 22. ERO curve of Pillsbury Moist Supreme Classic White Cake.

FIG. 23. ERO curve of Authentic Foods Gluten-free Vanilla Cake Mix.

FIG. 24. Example of acceptable cake (1.0 xanthan, 28% liquids).

FIG. 25. ERO curve corresponding to acceptable cake shown in FIG. 24.

FIG. 26. Example of unacceptable cake (0.8% xanthan, 27% liquids).

FIG. 27. ERO curve corresponding to unacceptable cake shown in FIG. 25.

FIG. 28. Example of an unacceptable cake (0.6% xanthan, 30% liquid).

FIG. 29. ERO curve corresponding to unacceptable cake shown in FIG. 28.

FIG. 30. Example of an unacceptable cake (1.2% xanthan, 29% liquid).

FIG. 31. ERO curve corresponding to unacceptable cake shown in FIG. 30.

FIG. 32. Example of unacceptable cake (1.4% xanthan, 26% liquid).

FIG. 33. ERO curve corresponding to unacceptable cake shown in FIG. 32.

FIG. 34. ERO curve for White Cake.

FIG. 35. ERO curve for Chocolate Cake.

FIG. 36. ERO curve for Yellow Cake.

### DETAILED DESCRIPTION

Accordingly, there is an increasing need for gluten replacement systems in food products, which not only reduce or eliminate gluten in a product, but which also result in food products that are comparable to their gluten-containing counterparts. There are numerous gluten-free products on the market, but most of these products, such as gluten-free bakery products, have a poor taste and eating quality, provide poor nutrition, and are sold at a high price to the consumer.

Successful gluten replacement, therefore, provides a difficult challenge to the food manufacturer. This is due to the multi-faceted role that gluten plays as an ingredient in a vast array of food products.

One possible approach to making gluten-free food products is to remove the gluten from the gluten-containing ingredients. Examples of gluten-removing technologies are as follows:
Extraction using various solvents and solutions, such as ethanol, solutions of salts (including lithium chloride), and aqueous solutions of various pH;
Combined extraction/High Pressure Liquid Chromatography (HPLC) procedures;
Fractionation extraction;
Water washing (which is similar to extraction, and may be combined with precipitation);
Centrifugation and ultracentrifugation;
Enzyme treatments (such as enzyme-assisted hydrolysis);
Gluten recovery using sieves; and,
Emulsification/agglomeration.

There are many potential problems associated with attempting to remove gluten from gluten-containing ingredients. First, gluten may not be completely removed from the ingredients, resulting in levels of gluten which may be unacceptably high for patients with celiac disease. Second, the removal of gluten from some ingredients may result in the removal of the functional polymers that these ingredients require in order to bring structure to food products. Third, the expense associated with removing gluten from gluten-containing ingredients on a commercial scale may result in food product prices that are unacceptably high for consumers.

Fourth, incomplete clean-up following extraction procedures may leave deleterious substances in the ingredients. Some extraction solvents and solutions are not safe for human consumption. Moreover, even extraction solvents and solutions that are safe for human consumption may leave unpleasant flavors or aromas in the food ingredients, or may lead to other unwanted results. For example, the incomplete removal of ethanol could depress yeast activity, and the changes in pH caused by certain extraction solvents or solutions could affect gelatinization temperatures.

A typical method for making gluten-free food products consists of using only ingredients derived from gluten-free starting materials. For instance, a bakery product may be made using a flour derived from a gluten-free food source, such as garbanzo beans, rather than a flour derived from a gluten-containing grain, such as wheat. Examples of gluten-free flours that may be used to make gluten-free bakery products are as follows: amaranth flour, arrowroot flour, brown rice flour, buckwheat flour, corn flour, cornmeal, garbanzo bean flour, garfava flour (a flour produced by Authentic Foods which is made from a combination of garbanzo beans and fava beans), millet flour, potato flour, quinoa flour, Romano bean flour, sorghum flour, soy flour, sweet rice flour, tapioca flour, teff flour, and white rice flour. However, this is not a comprehensive list of all flours that may be used to make gluten-free bakery products. Frequently, different gluten-free flours are combined to make a bakery product.

Examples of other possible ingredients in gluten-free bakery products, besides gluten-free flours, are as follows: starches, including potato starch and cornstarch; gums, including xanthan gum and guar gum; gelatin; eggs; egg replacers; sweeteners, including sugars, molasses, and honey; salt; yeast; chemical leavening agents, including baking powder and baking soda; fats, including margarine and butter; oils, including vegetable oil; vinegar; dough enhancer; dairy products, including milk, powdered milk, and yogurt; soy milk; nut ingredients, including almond meal, nut milk, and nut meats; seeds, including flaxseed, poppy seeds, and sesame seeds; fruit and vegetable ingredients, including fruit puree and fruit juice; and flavorings, including rye flavor powder, vanilla, cocoa powder, and cinnamon. However, this is not a comprehensive list of all ingredients that can be used to make gluten-free bakery products.

Most approaches to formulating gluten-free products involve the use of starches, dairy products, gums and hydrocolloids, and other non-gluten proteins. These materials tend to be hydrophilic and thus may require excessive amounts of water; in fact, the unbaked material is often a batter that is poured into the pan. During baking, the high water content leads to more fully pasted starch and in turn a more brittle, crumbly final texture and a shorter, less chewy bite.

The present invention is directed to preparing gluten-free batter-based products, such as cakes and muffins, that do not result in the brittle, crumbly or dense structure, low baked volume, poor symmetry, or less than optimal sensory qualities of typical gluten-free batter-based products, and are essentially the equivalent of conventional, wheat-containing batter-based products. As will be described below, the present invention utilizes an electrical resistance heating method for the heating of batter-based products as a means to optimize gluten-free batter based products having excellent textural and other properties. As a result of the electrical resistance heating method used in accordance with the present invention, the preparation of high quality, good tasting products that are comparable to their gluten-containing counterparts is possible. The gluten-free products made in accordance with the present invention are useful for the treatment of celiac disease, and are safe for consumption by those with a gluten-intolerant disorder, by those who in general have a gluten intolerance, allergy or sensitivity, or by those who have been placed on or choose to follow a gluten-free diet for medical or non-medical reasons.

Gluten is a cohesive protein mass containing primarily two groups of protein subunits—the lower molecular weight monomeric gliadins, having a molecular weight of between about 30,000 to about 125,000, and the higher molecular weight polymeric glutenins, having a molecular weight of between about 100,000 to 3,000,000 or higher.

Gluten contains both hydrophilic and hydrophobic amino acids, giving the protein mass both properties. Upon hydration, gliadins are viscous and extensible—they flow with gravity. As a result, gliadins are often considered plasticizers. Glutenins, on the other hand, upon hydration become very elastic, that is, they have a memory and are capable of returning to the original shape or approximately the original shape following deformation. This combination of properties of gluten imparts the cohesive and viscoelastic properties of a dough containing gluten, and provides gas-holding properties beneficial for successfully making many bakery products.

The protein composition of gluten also includes both ordered and random regions, short and long chain proteins, and linear and branched chains. This combination of opposing properties makes gluten an important component of the manufacturing and final qualities of bakery products, and is why it has been so difficult to replace gluten with other ingredients and still produce a suitable final bakery product.

Most batter-based products begin with wheat flour. Preferably, soft wheat flour, which has a lower protein content and produces a weaker gluten matrix than hard wheat flour, is used to provide the desired texture to batter-based products, such as cakes. To make the batter, the wheat flour and other dry ingredients are mixed with a liquid, such as water, and the continued mixing of the batter creates gas cells in the batter. As the formation and retention of gas cells in the batter during mixing is critical to the fineness of the grain of, for example, a cake, it is important that the gas cells are suitably formed and distributed, and do not coalesce or migrate while preparing and processing the batter. Major factors important to the creation and stability of gas cells in a batter include air incorporation during mixing, batter viscosity, batter density (i.e., the amount of air incorporated into the batter), and emulsification.

When a wheat flour-based batter is baked, as the temperature increases, the viscosity of the batter shows a sharp decrease, ultimately reaching a minimum viscosity, before sharply increasing as the end of the baking process approaches. This sharp rise in viscosity is attributable primarily to starch gelatinization and protein denaturation which sets the structure of the resulting baked product.

In a conventional wheat flour-based batter system, gluten has a very significant effect on water absorption and consequently initial batter viscosity and batter viscosity during baking. The starch contained in the wheat flour also plays a major role because it has a primary effect on setting the structure during baking and cooling. Conventional wheat starch is usually contaminated with gluten and hence is not useable in gluten-free baked product formulations. Gluten-free wheat starch, such as Codex wheat starch, is quite expensive and difficult to obtain in large quantities, adding to the cost of the resulting product. Furthermore, there are some people who are intolerant even to Codex wheat starch and cannot safely consume products that are labeled “gluten-free” but contain Codex wheat starch.

Without the presence of wheat flour, and therefore, gluten and wheat starch, in a batter system, the physical and chemical properties of the batter and the resulting product are vastly affected. Numerous attempts have been made to provide gluten-free ingredients that can mimic the properties of gluten and wheat starch, often resulting in products having less than satisfactory organoleptic properties, poor nutritional value, and an increased cost.

The present invention is directed to the use of electrical resistance heating to optimize gluten-free batter based products. Electrical resistance ovens can be manufactured according to the specifications provided in the following journal articles: Cereal Chemistry, volume 63:67 (1986), and Cereal Chemistry, volume 67(6):575 (1990). An electrical resistance oven, or “ERO”, utilizes the electrolytic properties of a batter or dough to conduct an electrical charge through the mass. The resistance of the batter or dough to conducting this charge generates heat and thus the batter or dough can be baked uniformly instead of from the outside in as in a conventional oven.

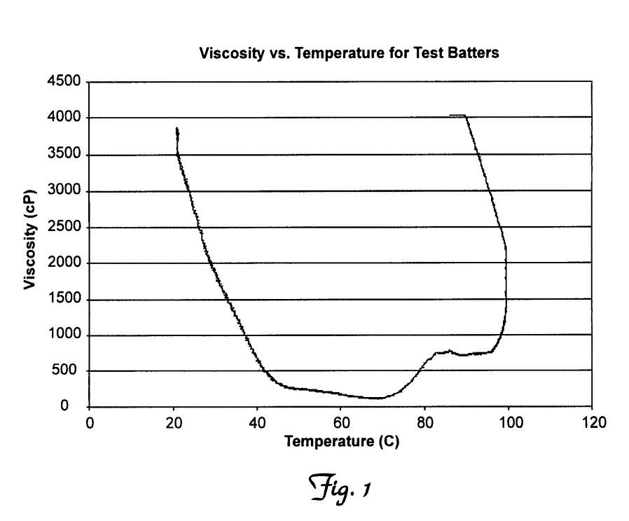

By suspending temperature and viscosity sensors in a batter, viscosity versus temperature curves can be generated that can be used to very efficiently develop an optimal product. A typical curve demonstrating the effects of using an ERO with a wheat flour batter appears in FIG. 1. Viscosity declines in the initial phase of the curves generated, reaches a minimum value, and then rises due to events such as gelatinization of the starch and coagulation of heat coaguable proteins. ERO curves for wheat flour-based cakes are described in Cereal Chemistry, volume 67(6):575 (1990).

The present invention is directed to the application of ERO technology to the development of gluten free cakes and other batter-based products, and contemplates the use of electrical resistance heating to the preparation of other gluten-free products, such as dough-based products. Parameters derived from these curves that appear to be important include minimum viscosity, temperature of setting (i.e., where viscosity begins to rise from the minimum), and the rate of cooling after the ERO is shut off.

In another embodiment of the present invention, ERO technology can be used as a quality assurance system to monitor the consistency of products being made on a commercial scale. For example, a sample of a dry mix can be made into a test batter, then subjected to ERO analysis to assure that the viscosity profile of the batter upon ERO heating meets the desired parameters. If modifications are needed to achieve the targeted viscosity profile, the levels of the dry mix ingredients can be adjusted to meet the viscosity parameters. In this way, formulation of the bulk dry mix can be adjusted as needed before the dry mix is distributed or used.

By utilizing the parameters obtained with the ERO, it is possible to optimize the gluten-free batter formulation and processing to provide a gluten-free product using conventional baking means, the product having a volume, textural and other organoleptic properties similar to that of a gluten-containing batter-based product.

Traditional batters and doughs are similar in many aspects, such as the types of ingredients used, but differ in other aspects, such as their rheological properties. Generally, batters are viscous, and can be poured within a reasonable amount of time, while doughs are viscoelastic, having both viscous and elastic properties. Batter-based products that can be made using the present invention include, but are not limited to, gluten-free cakes, muffins, pancakes, waffles, and the like. Also contemplated is the use of ERO to make gluten-free products traditionally made with dough, but which, due to the use of gluten-free ingredients, may take on more batter-like properties. It is believed that the present invention can be used to optimize the preparation of gluten-free dough products. Examples include, but are not limited to, bread, rolls, pizza, and the like. In addition, the present invention may also be used to optimize gluten-containing batters and doughs.

The following Examples are intended to further describe, but not limit, the present invention.

### EXAMPLE 1

A gluten-free cake was produced in accordance with the present invention. The gluten-free cake was made from a batter comprising approximately 26% liquids. The ingredients of this batter are listed in Table 1.

TABLE 1
Ingredients of a Gluten-Free Batter Comprising Approximately 26% Liquids

| | | | Amount of | Amount of |
|---|---|---|---|---|
| | Amount of | | Ingredient (as a % | Ingredient (as a % |
| | Ingredient | Amount of | of the Total | of the Weight of |
| | (in Baker's | Ingredient | Weight of | the Dry |
| Ingredient | %) | (in Grams) | Ingredients) | Ingredients) |
| Cargill Cream Gel | 90.00 | 355.97 | 23.73 | 32.23 |
| 70001 (tapioca starch) | | | | |
| Cargill Satiaxane CX | 1.00 | 3.96 | 0.264 | 0.36 |
| 91 Xanthan Gum | | | | |
| C&H Bakers Special | 115.00 | 454.85 | 30.32 | 41.18 |
| Sugar | | | | |
| Dana Foods Non-Fat | 7.00 | 27.69 | 1.85 | 2.51 |
| Dry Milk | | | | |
| Cargill Top Flo Salt | 2.50 | 9.89 | 0.66 | 0.90 |
| Kraft Calumet double | 3.75 | 14.83 | 0.99 | 1.34 |
| acting Baking Powder | | | | |
| Master Chef Cake and | 60.00 | 237.31 | 15.82 | 21.49 |
| Icing Shortening | | | | |
| Cargill Sunny Fresh | 80.00 | 316.41 | 21.09 | |
| Frozen Whole Eggs | | | | |
| Water | 20.00 | 79.10 | 5.27 | |
| Total (All Ingredients) | 379.25 | 1500 | 100 | |
| Total (Dry | | 1104.48 | 73.63 | |
| Ingredients) | | | | |
| Total (Liquid | | 395.52 | 26.37 | |
| Ingredients) | | | | |

The dry ingredients were mixed for two minutes on setting 1 (low speed). Shortening and liquid ingredients were added to the dry ingredients. The resulting mixture was mixed for one minute on setting 1, then for two minutes on setting 2 using a Hobart N-50 mixer. Batter was then scraped down from the sides of the bowl, and the batter was mixed for two additional minutes on setting 2. Approximately 370 g of batter were poured into an 8-inch round pan. The batter was then baked in a conventional oven at 350° F. for 25 minutes.

The resulting cake exhibited some voids and surface irregularities. The cake did not have a gum layer.

The height of the cake was measured according to the following procedure. The cake was sliced in half. The height of the cake was then measured along the cut edge of each half of the cake, at points A, B, C, D, and E, according to the American Association of Cereal Chemists (“AACC”) Method 10-91. Points A, B, C, D, and E correspond to points on the 8-inch layer cake-measuring template associated with AACC Method 10-91. Point C is the midpoint of the cake; points A and E are the endpoints of the cake; and points B and D are located on either side of the midpoint of the cake, between the midpoint and the edge. Using this AACC method, a volume index, uniformity index, and symmetry index can be calculated. It is generally preferable to have a higher volume index, and lower (close to 0) uniformity and symmetry indices.

The height measurements for this Example are provided in Table 2.

TABLE 2
Height Measurements of a Cake Made from a Gluten-Free Batter
Comprising Approximately 26% Liquids

| Portion of | | | | | |
|---|---|---|---|---|---|
| Cake | Point A | Point B | Point C | Point D | Point E |
| Measured | (in mm) | (in mm) | (in mm) | (in mm) | (in mm) |
| Half 1 | 28 | 38 | 38 | 38 | 36 |
| Half 2 | 30 | 38 | 40 | 42 | 36 |
| Average | 29 | 38 | 39 | 40 | 36 |

Volume, symmetry, and uniformity indices of the cake were calculated using the following equations:

Volume Index=B+C+D

Symmetry Index=2C−B−D

Uniformity Index=B−D

The values of the indices, which were calculated using the average width values in the above equations, are as follows:

Volume Index=117

Symmetry Index=0

Uniformity Index=−2

A sample of batter made according to the formula of Table 1 was baked in an electrical resistance oven (“ERO”). The batter was heated, and its temperature and viscosity measured, for 50 minutes, starting at 21.2° C. and ending at 99.3° C. It was subsequently cooled, and its temperature and viscosity measured, for 35 minutes to 79.9° C.

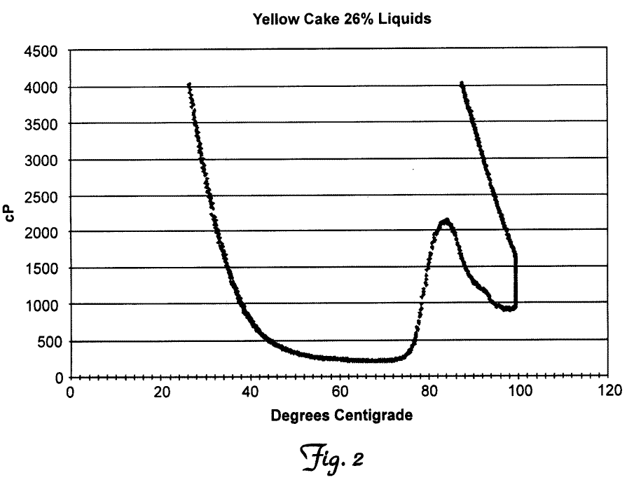

FIG. 2 shows the ERO curve of the viscosity of the batter versus temperature. This ERO curve was generated from data collected as the batter was heated and cooled in the ERO. The minimum viscosity of the ERO curve was 216.4 centipoise (cP). This minimum viscosity occurred when the temperature of the batter was 66.7° C. The temperature at the onset of the minimum of the curve was 40° C., while the temperature at the departure from the minimum of the curve was 76° C. After the batter reached the minimum viscosity, the viscosity increased, reaching a peak viscosity of 2155 cP at 84.2° C. This increase in viscosity may correspond to starch gelatinization and/or denaturation of the egg albumin.

The increase in the viscosity of this batter was followed by a decrease in viscosity. The viscosity decreased to a second minimum of 915 cP. This minimum viscosity occurred when the temperature of the batter was from 97.9° C. to 98.1° C. The cause of this decrease in viscosity is unclear, but it could be related to the sugar going into solution. When the ERO was shut off, the viscosity of the batter increased dramatically. The rate of the rise in viscosity as the batter cooled was 202 cP/° C., between 99.3° C. and 87.5° C.

### EXAMPLE 2

A gluten-free cake was produced in accordance with the present invention. The gluten-free cake was made from a batter comprising approximately 28% liquids.

The ingredients of this batter are listed in Table 3.

TABLE 3
Ingredients of a Gluten-Free Batter Comprising Approximately 28% Liquids

| | | | Amount of | Amount of |
|---|---|---|---|---|
| | | | Ingredient (as a | Ingredient (as a |
| | Amount of | Amount of | % of the Total | % of the Weight |
| | Ingredient (in | Ingredient | Weight of | of the Dry |
| Ingredient | Baker's %) | (in Grams) | Ingredients) | Ingredients) |
| Cargill Cream Gel | 90.00 | 348.79 | 23.25 | 32.23 |
| 70001 (tapioca | | | | |
| starch) | | | | |
| Cargill Satiaxane | 1.00 | 3.88 | 0.258 | 0.36 |
| CX 91 Xanthan Gum | | | | |
| C&H Bakers Special | 115.00 | 445.68 | 29.71 | 41.18 |
| Sugar | | | | |
| Dana Foods Non-Fat | 7.00 | 27.13 | 1.81 | 2.51 |
| Dry Milk | | | | |
| Cargill Top Flo Salt | 2.50 | 9.69 | 0.65 | 0.90 |
| Kraft Calumet | 3.75 | 14.53 | 0.97 | 1.34 |
| double acting | | | | |
| Baking Powder | | | | |
| Master Chef Cake | 60.00 | 232.53 | 15.50 | 21.49 |
| and Icing Shortening | | | | |
| Cargill Sunny Fresh | 80.00 | 310.04 | 20.67 | |
| Frozen Whole Eggs | | | | |
| Water | 27.80 | 107.74 | 7.18 | |
| Total (All | 387.05 | 1500 | 100 | |
| Ingredients) | | | | |
| Total (Dry | | 1082.22 | 72.15 | |
| Ingredients) | | | | |
| Total (Liquid | | 417.78 | 27.85 | |
| Ingredients) | | | | |

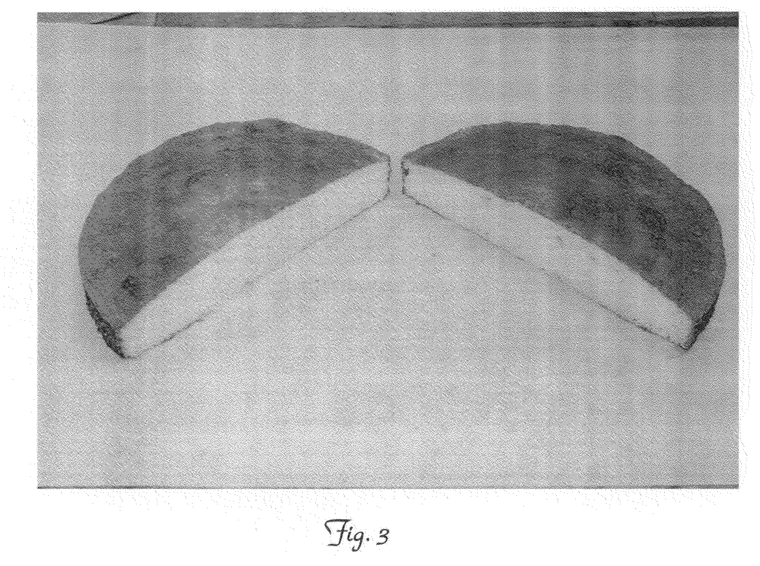

The dry ingredients were mixed for two minutes on setting 1 (low speed). Shortening and liquid ingredients were added to the dry ingredients. The resulting mixture was mixed for one minute on setting 1, then for two minutes on setting 2. Batter was then scraped down from the sides of the bowl, and the batter was mixed for two additional minutes on setting 2. Approximately 370 g of batter was poured into an 8-inch round pan. The batter was then baked in a conventional oven at 350° F. for 25 minutes. A photograph of the resulting cake, after it was sliced in half, is shown in FIG. 3.

The dry ingredients used in this cake were sifted. Voids in this cake were reduced, in comparison to a cake that was made in the same manner except for the use of unsifted ingredients.

A sample of batter made according to the formula of Table 3 was baked in an ERO. The batter was heated, and its temperature and viscosity measured, for 46 minutes, starting at 21.2° C. and ending at 99.3° C. It was subsequently cooled, and its temperature and viscosity measured, for 28 minutes to 79.9° C.

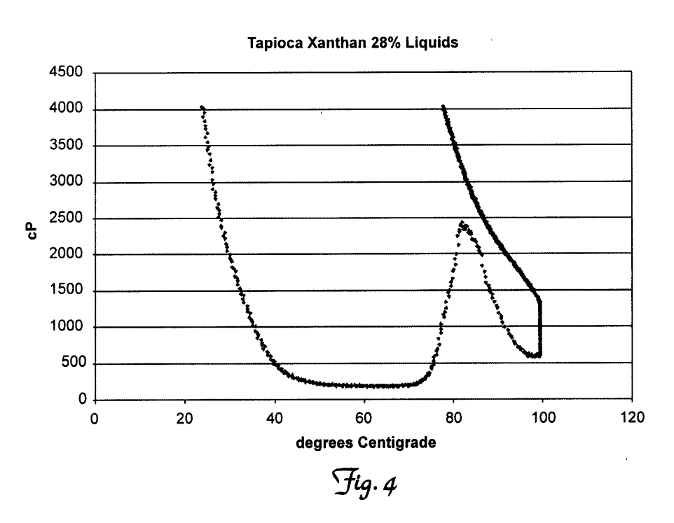

FIG. 4 shows the ERO curve of the viscosity of the batter versus temperature. This ERO curve was generated from data collected as the batter was heated and cooled in the ERO. The minimum viscosity of the ERO curve was 186 cP. This minimum viscosity occurred when the temperature of the batter was from 63° C. to 66° C. An increase in viscosity occurred at a temperature of approximately 80° C. This increase in viscosity may correspond to starch gelatinization and/or denaturation of the egg albumin.

The increase in the viscosity of this batter was followed by a decrease in viscosity. The cause of this decrease in viscosity is unclear, but it could be related to the sugar going into solution. When the ERO was shut off, the viscosity of the batter increased dramatically.

Another gluten-free cake was made in accordance with the present invention, using the same formula (see Table 3) and procedure. The cake was baked in a conventional oven. The resulting cake exhibited some voids and surface irregularities. The cake did not have a gum layer.

The height of the cake was measured according to the procedure discussed in Example 1. The measurements are provided in Table 4.

TABLE 4
Height Measurements of a Cake Made from a Gluten-Free Batter
Comprising Approximately 28% Liquids

| Portion of | | | | | |
|---|---|---|---|---|---|
| Cake | Point A | Point B | Point C | Point D | Point E |
| Measured | (in mm) | (in mm) | (in mm) | (in mm) | (in mm) |
| Half 1 | 30 | 40 | 42 | 36 | 30 |
| Half 2 | 30 | 36 | 42 | 38 | 30 |
| Average | 30 | 38 | 42 | 37 | 30 |

Volume, symmetry, and uniformity indices of the cake were calculated using the following equations:

Volume Index=B+C+D

Symmetry Index=2C−B−D

Uniformity Index=B−D

The values of the indices, which were calculated using the average width values in the above equations, are as follows:

Volume Index=117

Symmetry Index=9

Uniformity Index=1

A sample of batter made according to the formula of Table 3 was baked in an ERO. The batter was heated, and its temperature and viscosity measured, for 46 minutes, starting at 21.2° C. and ending at 99.3° C. It was subsequently cooled, and its temperature and viscosity measured, for 28 minutes to 79.9° C.

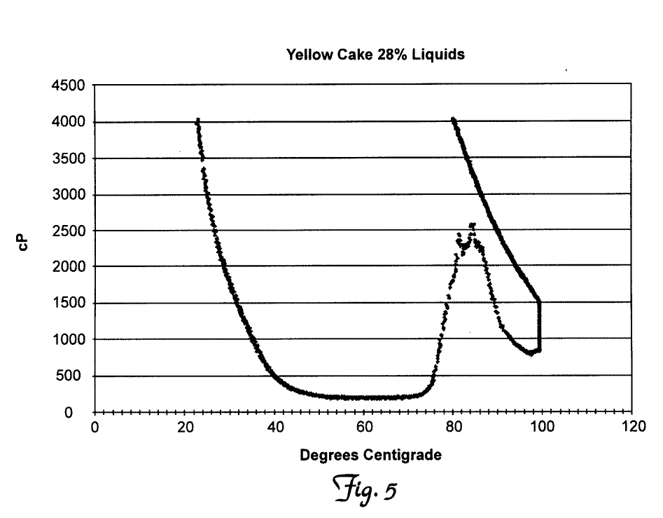

FIG. 5 shows the ERO curve of the viscosity of the batter versus temperature. This ERO curve was generated from data collected as the batter was heated and cooled in the ERO. The minimum viscosity of the ERO curve was 196.5 cP. This minimum viscosity occurred when the temperature of the batter was from 56° C. to 66° C. The temperature at the onset of the minimum of the curve was 41° C., while the temperature at the departure from the minimum of the curve was 75° C. After the batter reached the minimum viscosity, the viscosity increased, reaching a peak viscosity of 2588 cP at 84.8° C. This increase in viscosity may correspond to starch gelatinization and/or denaturation of the egg albumin.

The increase in the viscosity of this batter was followed by a decrease in viscosity. The viscosity decreased to a second minimum of 790.7 cP at 97.5° C. The cause of this decrease in viscosity is unclear, but it could be related to the sugar going into solution. When the ERO was shut off, the viscosity of the batter increased dramatically. The rate of the rise in viscosity as the batter cooled was 131 cP/° C., between about 100° C. and 80° C.

### EXAMPLE 3

A gluten-free cake was produced in accordance with the present invention. The gluten-free cake was made from a batter comprising approximately 31% liquids.

The ingredients of this batter are listed in Table 5.

TABLE 5
Ingredients of a Gluten-Free Batter Comprising Approximately 31% Liquids

| | | | Amount of | Amount of |
|---|---|---|---|---|
| | | | Ingredient (as a | Ingredient (as a |
| | Amount of | Amount of | % of the Total | % of the Weight |
| | Ingredient (in | Ingredient (in | Weight of | of the Dry |
| Ingredient | Baker's %) | Grams) | Ingredients) | Ingredients) |
| Cargill Cream | 90.00 | 333.13 | 22.21 | 32.23 |
| Gel 70001 | | | | |
| (tapioca starch) | | | | |
| Cargill Satiaxane | 1.00 | 3.70 | 0.247 | 0.36 |
| CX91 Xanthan | | | | |
| Gum | | | | |
| C&H Bakers | 115.00 | 425.66 | 28.38 | 41.18 |
| Special Sugar | | | | |
| Dana Foods | 7.00 | 25.91 | 1.73 | 2.51 |
| Non-Fat Dry | | | | |
| Milk | | | | |
| Cargill Top Flo | 2.50 | 9.25 | 0.62 | 0.90 |
| Salt | | | | |
| Kraft Calumet | 3.75 | 13.88 | 0.93 | 1.34 |
| double acting | | | | |
| Baking Powder | | | | |
| Master Chef | 60.00 | 222.09 | 14.81 | 21.49 |
| Cake and Icing | | | | |
| Shortening | | | | |
| Cargill Sunny | 80.00 | 296.11 | 19.74 | |
| Fresh Frozen | | | | |
| Whole Eggs | | | | |
| Water | 46.00 | 170.27 | 11.35 | |
| Total (All | 405.25 | 1500 | 100 | |
| Ingredients) | | | | |
| Total (Dry | | 1033.62 | 68.91 | |
| Ingredients) | | | | |
| Total (Liquid | | 466.38 | 31.09 | |
| Ingredients) | | | | |

The dry ingredients were mixed for two minutes on setting 1 (low speed). Shortening and liquid ingredients were added to the dry ingredients. The resulting mixture was mixed for one minute on setting 1, then for two minutes on setting 2. Batter was then scraped down from the sides of the bowl, and the batter was mixed for two additional minutes on setting 2. Approximately 370 g of batter were poured into an 8-inch round pan. The batter was then baked in a conventional oven at 350° F. for 25 minutes.

The resulting cake had a lower volume than the cakes of the previous examples. The cake exhibited some voids and surface irregularities. The cake had a slight gum layer.

The height of the cake was measured according to the procedure described in Example 1. The measurements are provided in Table 6.

TABLE 6
Height Measurements of a Cake Made from a Gluten-Free Batter
Comprising Approximately 31% Liquids

| Portion of | | | | | |
|---|---|---|---|---|---|
| Cake | Point A | Point B | Point C | Point D | Point E |
| Measured | (in mm) | (in mm) | (in mm) | (in mm) | (in mm) |
| Half 1 | 24 | 28 | 37 | 30 | 22 |
| Half 2 | 24 | 28 | 37 | 30 | 22 |
| Average | 24 | 28 | 37 | 30 | 22 |

Volume, symmetry, and uniformity indices of the cake were calculated using the following equations:

Volume Index=B+C+D

Symmetry Index=2C−B−D

Uniformity Index=B−D

The values of the indices, which were calculated using the average width values in the above equations, are as follows:

Volume Index=95

Symmetry Index=16

Uniformity Index=−2

A sample of batter made according to the formula of Table 5 was baked in an ERO. The batter was heated, and its temperature and viscosity measured, for 45 minutes, starting at 21.2° C. and ending at 99.3° C. It was subsequently cooled, and its temperature and viscosity measured, for 25 minutes to 79.2° C.

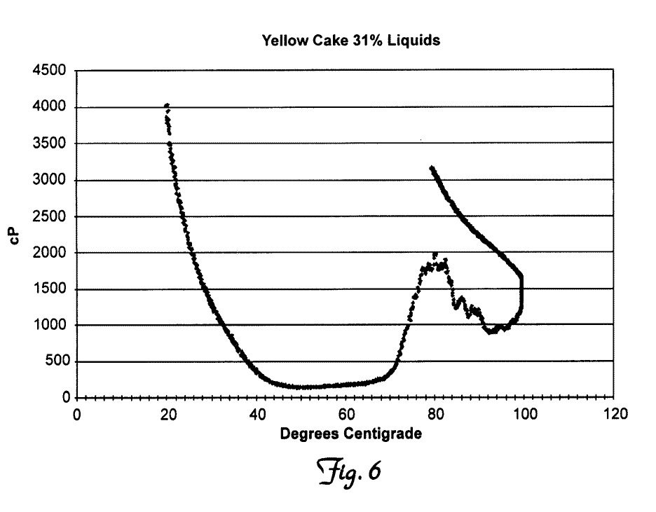

FIG. 6 shows the ERO curve of the viscosity of the batter versus temperature. This ERO curve was generated from data collected as the batter was heated and cooled in the ERO. The minimum viscosity of the ERO curve was 142 cP. This minimum viscosity occurred when the temperature of the batter was from 49.4° C. to 52.1° C. The temperature at the onset of the minimum of the curve was 41° C., while the temperature at the departure from the minimum of the curve was 70° C. After the batter reached the minimum viscosity, the viscosity increased, reaching a peak viscosity of 1984 cP at 80.3° C. This increase in viscosity may correspond to starch gelatinization and/or denaturation of the egg albumin.

The increase in the viscosity of this batter was followed by a decrease in viscosity. The viscosity decreased to a second minimum of 895 cP, at 92.2° C. The cause of this decrease in viscosity is unclear, but it could be related to the sugar going into solution. When the ERO was shut off, the viscosity of the batter increased dramatically. The rate of the rise in viscosity as the batter cooled was 75.9 cP/° C., between about 100° C. and 80° C.

### Analysis of Examples 1-3

Some of the parameters measured in the foregoing Examples are summarized for comparison in the table below.

TABLE 7
Comparison of Conventionally-Baked Gluten-Free
Cake and ERO Parameters

| | Conventional | | | ERO Parameters | | |
|---|---|---|---|---|---|---|
| | Cake Parameters | | | | | Rate of |
| % Liquid | Volume | Symmetry | Uniformity | Minimum | Setting | setting upon |
| in Batter | index | index | index | viscosity | onset T | cooling |
| 26% | 117 | 0 | −2 | 216.4 cP | 76° C. | 202 cP/° C. |
| 28% | 117 | 9 | 1 | 196.5 cP | 75° C. | 131 cP/° C. |
| 31% | 95 | 16 | −2 | 142 cP | 70° C. | 75.9 cP/° C. |

As can be seen from Table 7, as the ERO values change based on the formulation, the baked product parameters are affected. In accordance with the present invention, optimizing the gluten-free batter formulation to achieve desired parameters in an electrical resistance oven can be used to develop high quality gluten-free batter based products.

### EXAMPLE 4

To establish relationships between the ERO parameters and a conventional gluten-free yellow cake, the gluten-free cake formulation set forth in Table 3 was used as a center point from which a factorial design was performed based on xanthan gum, starch type and liquid concentrations. Xanthan gum concentrations of 0.8, 1.0 and 1.2 bakers' percent and liquid concentrations of 27, 28 and 29 total percent were used. Liquid level is defined as the total percentage of the combined amounts of water and eggs in the formula. Liquid levels in this design were altered by adjusting water additions only. Two sources of starch were used in this study, tapioca and wheat starch.

The finished batter weight for each formulation was 1750 grams, providing enough batter to bake two conventional cakes in eight inch round baking pans (370 grams batter each) and one ERO cake, for each formulation. The conventional cakes were baked in a conventional oven at 350 degrees Fahrenheit for 25 minutes. The ERO cakes were baked in an ERO at a Variac setting of 60% of full electrical output until internal temperature reached about 100° C. The Variac setting was kept constant throughout the bakes of the ERO cakes. However, the heating profile changed with the formulation because ERO baking is based on resistive heating, and current is conveyed differently through thick and thin batters. For each ERO cake, the batter was heated, and its temperature and viscosity measured, for about 30-60 minutes, starting at about 20° C. and ending at about 100° C. It was subsequently cooled, and its temperature and viscosity measured, for about 25-35 minutes to about 80° C.

Cake quality was assessed on the conventional cakes and ERO cakes. American Association of Cereal Chemists International (AACC) approved method 10-91 was used to determine the conventional cake geometry (volume, symmetry and uniformity). Texture profile analysis (TPA) was also conducted at initial texture (one hour out of oven) and at 24 hours after baking texture.

A texture analyzer (TA-XT2i, Stable Micro System, Scarsdale, N.Y.) was used to conduct TPA on the conventional cakes. The texture analyzer was equipped with a five kg load cell and a round two inch diameter compression platen probe. The cakes were sliced in half producing two half circles, one cake half was stored in a plastic bag for 24 hours while the other half was used to determine initial texture. The cake halves were cut horizontality to a height of ¾ of an inch exposing the top crumb structure. A 1.5 inch diameter “cookie cutter” was used to remove three cylinders from each cake half. To perform the TPA, a “cake crumb cylinder” was placed under the probe and was compressed to 50% of its original height at a constant speed of 1 mm/s. After the initial compression, the probe retracted 5 mm off the cake followed by a second compression to 50% of the original height.

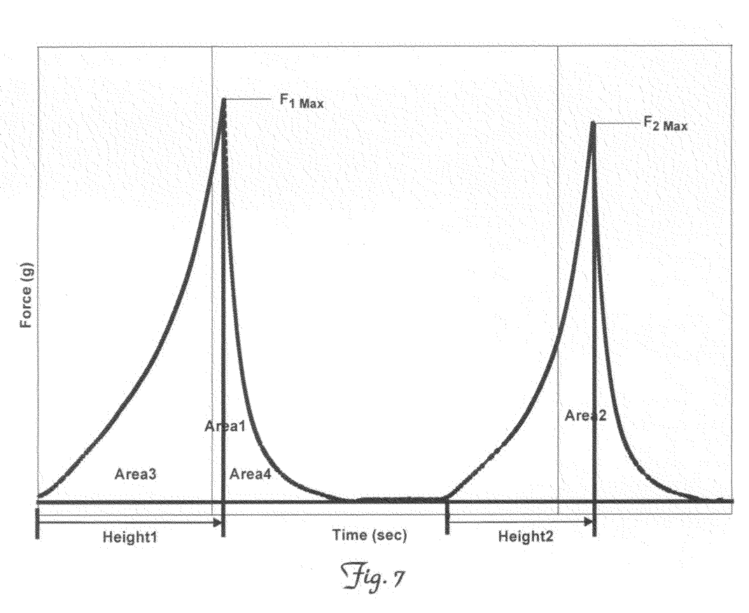

A typical TPA curve is shown in FIG. 7. From a TPA curve various texture parameters can be directly obtained or calculated. The parameters were obtained using the methods of Bourne (Food Technology, volume 32(7):62-66 (1978)). The obtained parameters include: hardness, cohesiveness, springiness, resilience, gumminess and chewiness. All parameters were measured initially and after 24 hours. A description of each texture parameter is below (see Cereal Chemistry, volume 83(6):684 (2006)).

Hardness: Force required to compress cake cylinder to 50% of the original height (F_{1 Max})(g)

Height1: Distance probe travels to reach F_{1 Max} (mm)

Height2: Distance probe travels to reach F_{2 Max} (mm)

Area1: Work of first compression (area under first curve to reach F_{1 Max}) (g/mm)

Area2: Work of second compression (area under second curve to reach F_{2 Max}) (g/mm)

Area3: Work to reach F_{1 Max} (area under first curve to reach F_{1 Max}) (g/mm)

Area4: Work after F_{1 Max} (area under first curve after F_{1 Max}) (g/mm)

Cohesiveness: Area2/Area1

Springiness: Height2/Height1

Resilience: Area4/Area3

Gumminess: Hardness×Cohesiveness; (F_{1 Max})×(Area2/Area1)

Chewiness: Gumminess×Springiness; (F_{1 Max})×(Area2/Area1)×(Height2/Height1)

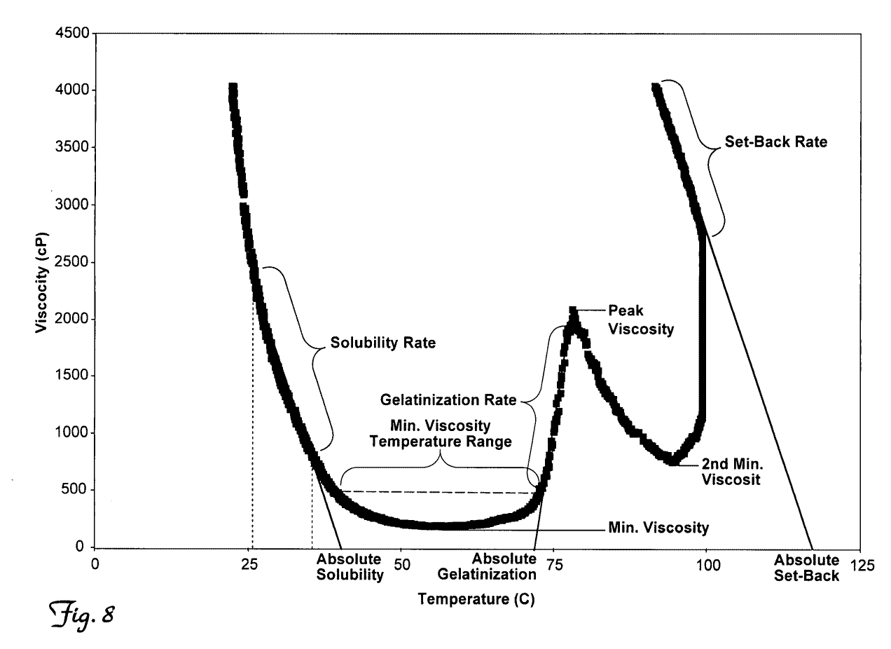

ERO cakes experiments resulted in a viscosity profile plot of the change in batter/cake viscosity as a function of temperature. A number of ERO parameters were directly obtained or calculated including: minimum viscosity, temperature at minimum viscosity, peak viscosity, temperature at peak viscosity, second minimum viscosity, temperature at second minimum viscosity, minimum viscosity range, gelatinization rate, solubility rate, set-back, absolute solubility, absolute gelatinization and absolute set-back (FIG. 8). A description of each parameter is below.

Minimum viscosity: The viscosity of the batter at its minimum.

Peak viscosity: Greatest viscosity between the minimum viscosity and second minimum viscosity.

Second minimum viscosity: The minimum viscosity after the peak viscosity.

Minimum viscosity temperature range: Temperature range of viscosity readings below 500 cP.

Solubility rate: Change in viscosity per unit change in temperature estimated by least squares linear regression using Microsoft Excel (2000) in the region of the ERO profile between 25° C. and 35° C.

Gelatinization rate: Change in viscosity per unit change in temperature estimated by least squares linear regression using Microsoft Excel (2000) in the region of the ERO profile from second 500 cP reading to 50 cP below the peak viscosity.

Set-back: Change in viscosity per unit change in temperature estimated by least squares linear regression using Microsoft Excel (2000) in the region of the ERO profile when the ERO electricity current is stopped to the maximum viscosity measured by the viscometer, (˜4037.5 cP).

Absolute solubility: The theoretical temperature at which the solubility reaches zero viscosity estimated by least squares linear regression using Microsoft Excel (2000) in the region of the ERO profile between 25° C. and 35° C.

Absolute Gelatinization: The theoretical temperature at which the gelatinization reaches zero viscosity estimated by least squares linear regression using Microsoft Excel (2000) in the region of the ERO profile from second 500 cP reading to 50 cP below the peak viscosity.

Absolute Set-back: The theoretical temperature at which the set-back reaches zero viscosity estimated by least squares linear regression using Microsoft Excel (2000) in the region of the ERO profile when the ERO electricity current is stopped to the maximum viscosity measured by the viscometer, (˜4037.5 cP).

To determine relationships between ERO parameters and conventional cake parameters, coefficient of determinations (r²) were determined for each measured parameter by least squares linear regression (Table 8). The Correlation Analysis Tool in Microsoft Excel (2000) was used to calculate the coefficient of determinations. Given n observations on two variables x and y denoted by

(x₁, y₁), (x₂, y₂), . . . , (xₙ, yₙ),

the coefficient of determination is defined as

$${r}^{2} ( x , y ) = 1 - \frac{RSS}{SYY}$$

where RSS is the residual sum of squares (the smallest possible value of the residual sum of squares function) and SYY is the total sum of squares of the y's. Given the standard linear regression model yᵢ=a+bᵢ+εᵢ, a and b are coefficients, y and x are the regressand and the regressor, respectively, and ε is the error term. The residual sum of squares is the sum of squares of estimates of εᵢ

$$RSS = {\sum }_{i = 1}^{n} {( {y}_{i} - ( a + {bx}_{i} ) )}^{2} .$$

The total sum of squares of the y's is the sum of the squares of the difference of the regressand variable and its mean

$$SYY = \sum {( {y}_{i} - \overline{y} )}^{2} .$$

If one thinks of SYY as the total variability in the sample, and RSS as the variability remaining after conditioning on x, then r² can be interpreted as the proportion of variability explained by conditioning on x.

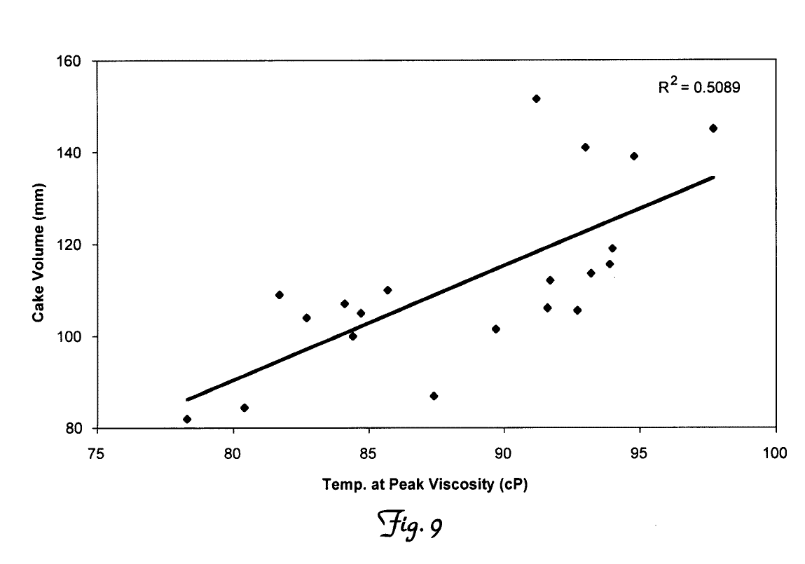

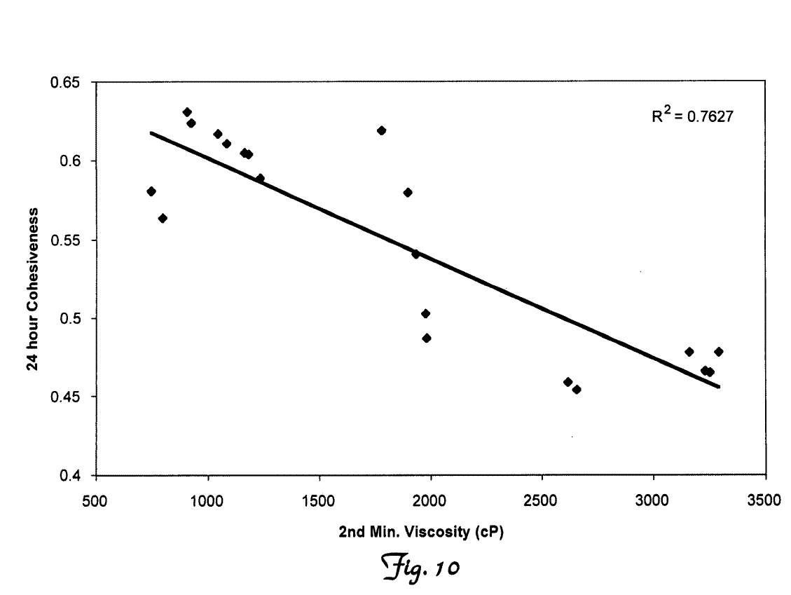

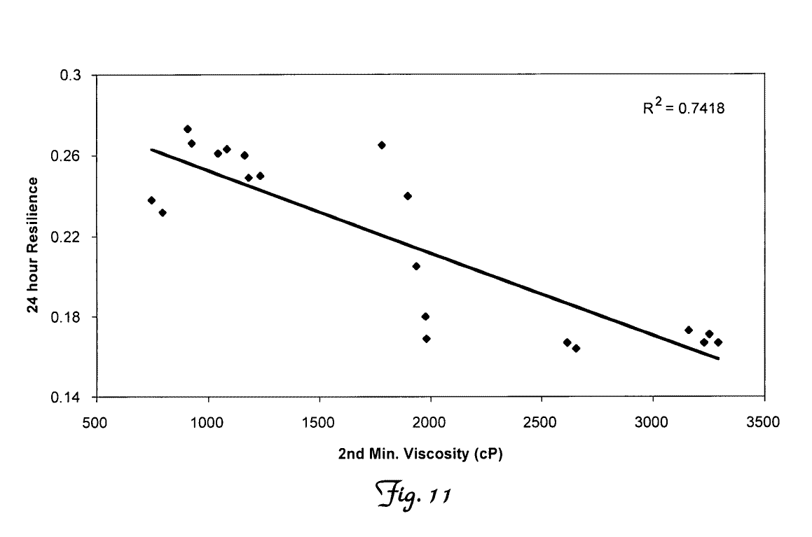

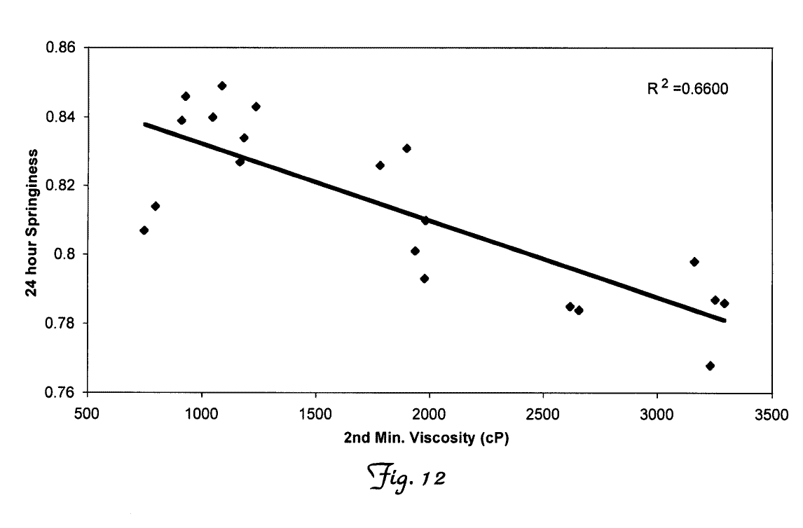

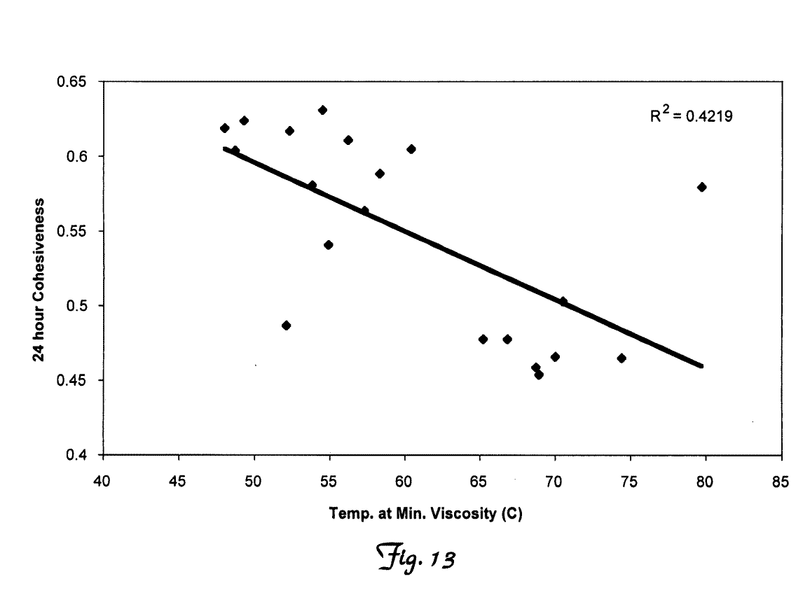

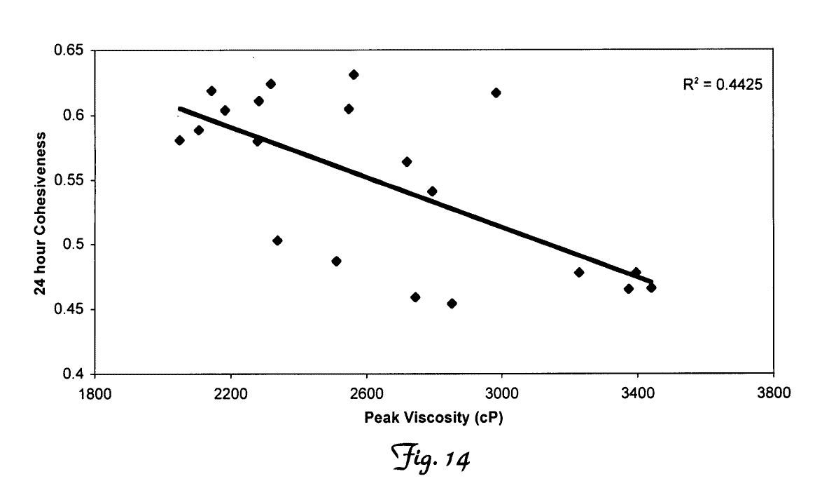

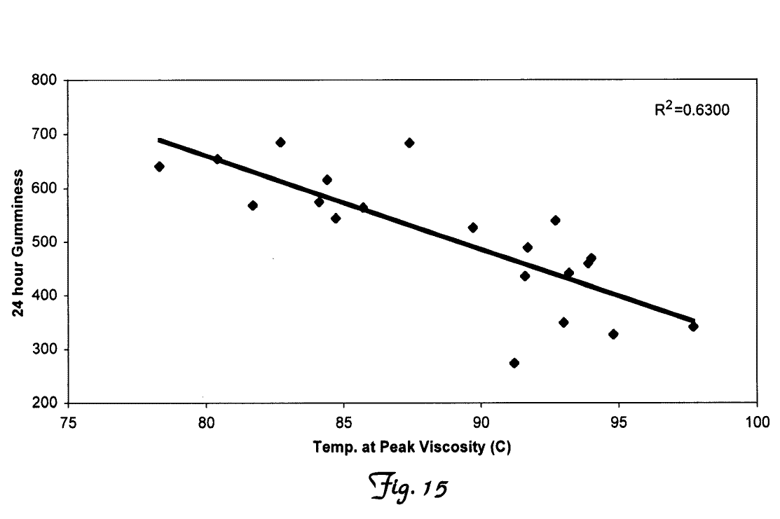

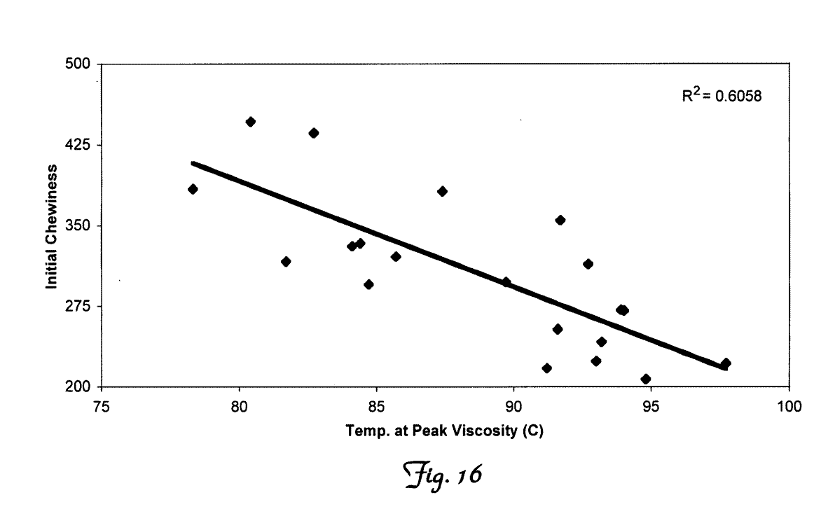

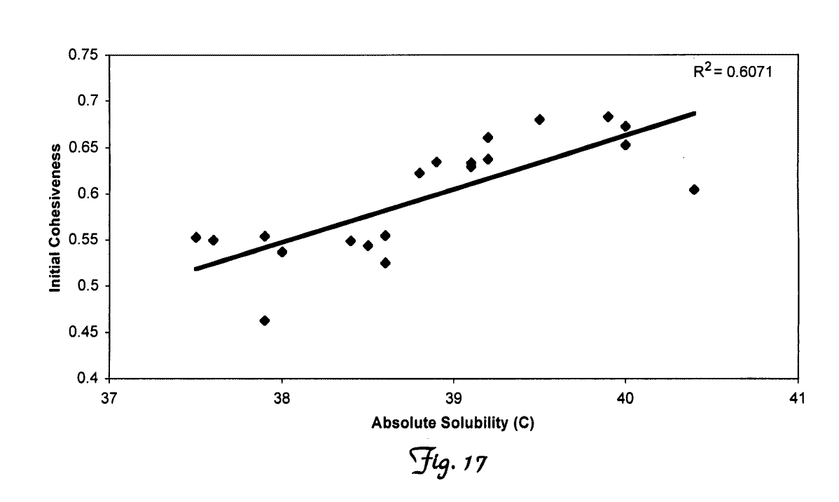

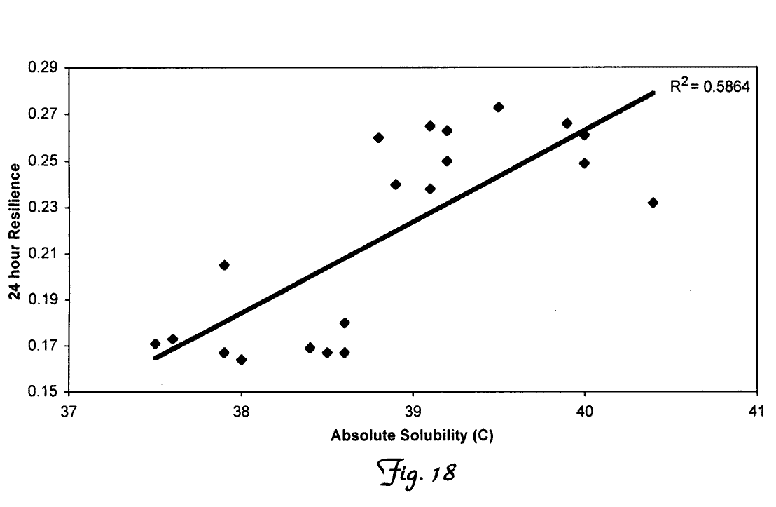

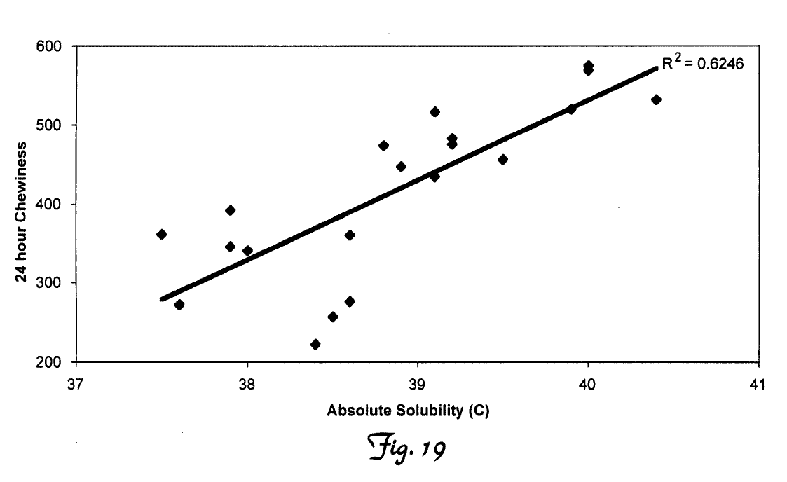

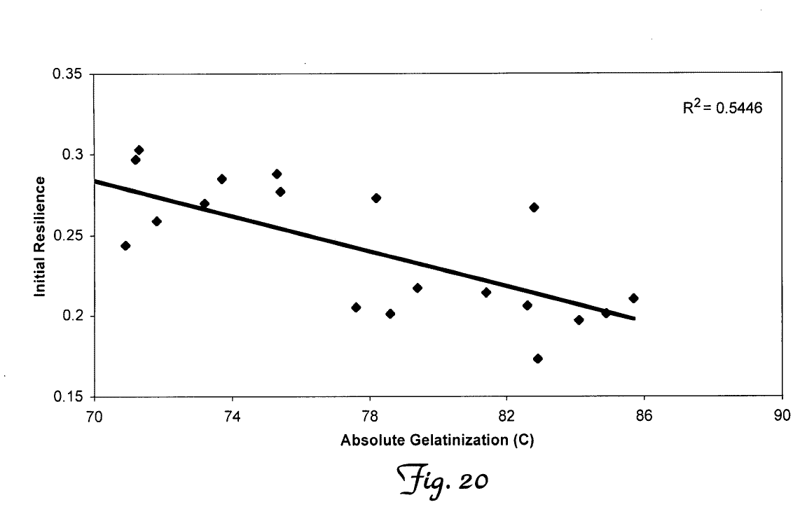

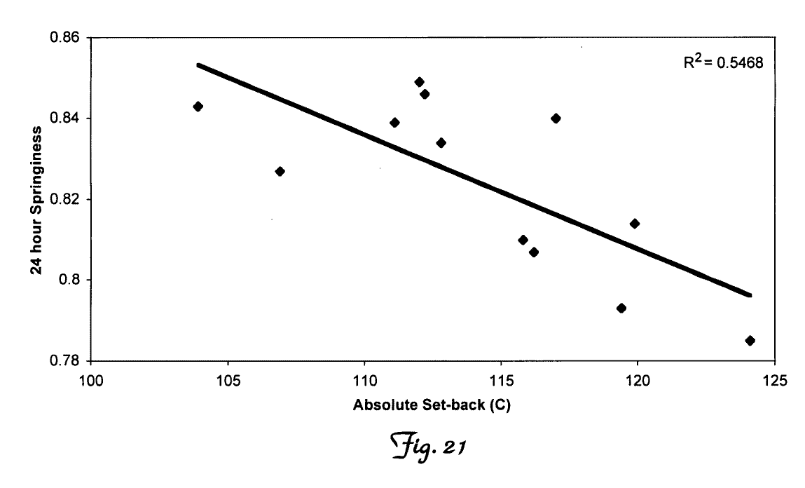

The results indicate a relationship between ERO parameters and conventional cakes parameters exist. Specific relationships between conventional and ERO parameters are shown in FIGS. 9-21. The existence of these relationships indicates that the ERO can be used as a tool to develop and define high quality gluten-free cakes. Table 8 is a correlation table representing acceptable gluten-free cakes evaluated.

TABLE 8
Linear Regression Analysis of ERO and Conventional Cake Parameters

| | | Temp. at | | Temp. at | | Temp. at | Min. | | |
|---|---|---|---|---|---|---|---|---|---|
| | Min. | Min. | Peak | Peak | 2nd Min. | 2nd Min. | Viscosity | | Solubility |
| | Viscosity | Viscosity | Viscosity | Viscosity | Viscosity | Viscosity | Temp. | Gelatinization | Rate |
| | (cP) | (° C.) | (cP) | (° C.) | (cP) | (° C.) | Range (° C.) | Rate (cP/° C.) | (cP/° C.) |
| Min. Viscosity (cP) | 1.000 | | | | | | | | |
| Temp. at Min. Viscosity (C.) | 0.037 | 1.000 | | | | | | | |
| Peak Viscosity (cP) | 0.074 | 0.138 | 1.000 | | | | | | |
| Temp. at Peak Viscosity (C.) | 0.246 | 0.346 | 0.355 | 1.000 | | | | | |
| 2nd Min. Viscosity (cP) | 0.111 | 0.490 | 0.536 | 0.854 | 1.000 | | | | |
| Temp. at 2nd Min. Viscosity | 0.148 | 0.097 | 0.097 | 0.540 | 0.431 | 1.000 | | | |
| (C.) | | | | | | | | | |
| Min. Viscosity Temp. Range | 0.460 | 0.064 | 0.259 | 0.688 | 0.600 | 0.650 | 1.000 | | |
| (C.) | | | | | | | | | |
| Gelatinization Rate (cP/° C.) | 0.019 | 0.000 | 0.389 | 0.007 | 0.035 | 0.000 | 0.001 | 1.000 | |
| Solubility Rate (cP/° C.) | 0.674 | 0.282 | 0.011 | 0.001 | 0.018 | 0.002 | 0.108 | 0.053 | 1.000 |
| Set-Back (cP/° C.) | 0.225 | 0.020 | 0.062 | 0.004 | 0.001 | 0.002 | 0.004 | 0.022 | 0.271 |
| Absolute Solubility (° C.) | 0.027 | 0.445 | 0.176 | 0.365 | 0.489 | 0.258 | 0.200 | 0.030 | 0.345 |
| Absolute Gelatinization (° C.) | 0.099 | 0.290 | 0.642 | 0.691 | 0.858 | 0.476 | 0.573 | 0.195 | 0.022 |
| Absolute Set-back (° C.) | 0.386 | 0.055 | 0.111 | 0.218 | 0.303 | 0.061 | 0.195 | 0.003 | 0.207 |
| Volume (mm) | 0.151 | 0.076 | 0.254 | 0.548 | 0.462 | 0.459 | 0.687 | 0.011 | 0.010 |
| Symmetry | 0.286 | 0.163 | 0.039 | 0.059 | 0.008 | 0.036 | 0.260 | 0.001 | 0.294 |
| Uniformity | 0.074 | 0.032 | 0.168 | 0.149 | 0.133 | 0.005 | 0.121 | 0.065 | 0.007 |
| Initial Hardness (g) | 0.005 | 0.067 | 0.032 | 0.290 | 0.260 | 0.570 | 0.400 | 0.000 | 0.006 |
| 24 Hour Hardness (g) | 0.173 | 0.007 | 0.137 | 0.364 | 0.252 | 0.303 | 0.511 | 0.002 | 0.072 |
| Initial Cohesiveness | 0.023 | 0.535 | 0.375 | 0.597 | 0.768 | 0.268 | 0.380 | 0.045 | 0.083 |
| 24 Hour Cohesiveness | 0.116 | 0.468 | 0.363 | 0.668 | 0.812 | 0.330 | 0.436 | 0.015 | 0.012 |
| Initial Springiness | 0.003 | 0.287 | 0.044 | 0.068 | 0.144 | 0.000 | 0.017 | 0.002 | 0.067 |
| 24 Hour Springiness | 0.012 | 0.623 | 0.290 | 0.382 | 0.602 | 0.133 | 0.163 | 0.035 | 0.088 |
| Initial Resilience | 0.066 | 0.391 | 0.384 | 0.575 | 0.713 | 0.263 | 0.443 | 0.058 | 0.023 |
| 24 Hour Resilience | 0.167 | 0.388 | 0.364 | 0.681 | 0.794 | 0.371 | 0.511 | 0.017 | 0.001 |
| Initial Gumminess | 0.006 | 0.174 | 0.092 | 0.421 | 0.430 | 0.617 | 0.473 | 0.004 | 0.027 |
| 24 Hour Gumminess | 0.179 | 0.136 | 0.276 | 0.616 | 0.563 | 0.410 | 0.614 | 0.000 | 0.017 |
| Initial Chewiness | 0.005 | 0.204 | 0.102 | 0.449 | 0.467 | 0.621 | 0.488 | 0.004 | 0.034 |
| 24 Hour Chewiness | 0.164 | 0.179 | 0.300 | 0.638 | 0.612 | 0.408 | 0.603 | 0.001 | 0.008 |

| | | Absolute | Absolute | Absolute | | | | Initial | 24 Hour |
|---|---|---|---|---|---|---|---|---|---|
| | Set-Back | Solubility | Gelatinization | Setback | Volume | | | Hardness | Hardness |
| | (cP/° C.) | (° C.) | (° C.) | (° C.) | (mm) | Symmetry | Uniformity | (g) | (g) |
| Min. Viscosity (cP) | | | | | | | | | |
| Temp. at Min. Viscosity (° C.) | | | | | | | | | |
| Peak Viscosity (cP) | | | | | | | | | |
| Temp. at Peak Viscosity (° C.) | | | | | | | | | |
| 2nd Min. Viscosity | | | | | | | | | |
| Temp. at 2nd Min. Viscosity | | | | | | | | | |
| (° C.) | | | | | | | | | |
| Min. Viscosity Temp. Range | | | | | | | | | |
| (° C.) | | | | | | | | | |
| Gelatinization Rate (cP/° C.) | | | | | | | | | |
| Solubility Rate (cP/° C.) | | | | | | | | | |
| Set-Back (cP/° C.) | 1.000 | | | | | | | | |
| Absolute Solubility (° C.) | 0.191 | 1.000 | | | | | | | |
| Absolute Gelatinization (° C.) | 0.038 | 0.463 | 1.000 | | | | | | |
| Absolute Set-back (° C.) | 0.595 | 0.006 | 0.339 | 1.000 | | | | | |
| Volume (mm) | 0.017 | 0.306 | 0.477 | 0.035 | 1.000 | | | | |
| Symmetry | 0.034 | 0.007 | 0.034 | 0.029 | 0.429 | 1.000 | | | |
| Uniformity | 0.016 | 0.149 | 0.182 | 0.150 | 0.333 | 0.229 | 1.000 | | |
| Initial Hardness (g) | 0.046 | 0.250 | 0.249 | 0.005 | 0.560 | 0.067 | 0.037 | 1.000 | |
| 24 Hour Hardness (g) | 0.001 | 0.171 | 0.270 | 0.051 | 0.895 | 0.671 | 0.372 | 0.739 | 1.000 |
| Initial Cohesiveness | 0.034 | 0.701 | 0.702 | 0.181 | 0.424 | 0.002 | 0.269 | 0.153 | 0.241 |
| 24 Hour Cohesiveness | 0.000 | 0.694 | 0.727 | 0.404 | 0.374 | 0.005 | 0.283 | 0.173 | 0.238 |
| Initial Springiness | 0.084 | 0.220 | 0.096 | 0.032 | 0.001 | 0.055 | 0.072 | 0.073 | 0.000 |
| 24 Hour Springiness | 0.009 | 0.502 | 0.529 | 0.451 | 0.096 | 0.060 | 0.144 | 0.020 | 0.035 |
| Initial Resilience | 0.009 | 0.601 | 0.701 | 0.241 | 0.479 | 0.032 | 0.363 | 0.131 | 0.321 |
| 24 Hour Resilience | 0.003 | 0.628 | 0.749 | 0.428 | 0.446 | 0.029 | 0.330 | 0.206 | 0.307 |
| Initial Gumminess | 0.061 | 0.423 | 0.405 | 0.000 | 0.641 | 0.043 | 0.080 | 0.949 | 0.758 |
| 24 Hour Gumminess | 0.000 | 0.434 | 0.538 | 0.156 | 0.880 | 0.360 | 0.430 | 0.653 | 0.857 |
| Initial Chewiness | 0.074 | 0.474 | 0.434 | 0.000 | 0.652 | 0.039 | 0.093 | 0.919 | 0.749 |
| 24 Hour Chewiness | 0.000 | 0.485 | 0.581 | 0.184 | 0.838 | 0.294 | 0.433 | 0.602 | 0.799 |

| | | | Initial | 24 Hour | Initial | 24 Hour | Initial | | | |
|---|---|---|---|---|---|---|---|---|---|---|
| | Initial | 24 Hour | Springi- | Springi- | Resil- | Resil- | Gummi- | 24 Hour | Initial | 24 Hour |
| | Cohesiveness | Cohesiveness | ness | ness | ience | ience | ness | Gumminess | Chewiness | Chewiness |
| Min. Viscosity (cP) | | | | | | | | | | |
| Temp. at Min. Viscosity (° C.) | | | | | | | | | | |
| Peak Viscosity (cP) | | | | | | | | | | |
| Temp. at Peak Viscosity (° C.) | | | | | | | | | | |
| 2nd Min. Viscosity | | | | | | | | | | |
| Temp. at 2nd Min. Viscosity | | | | | | | | | | |
| (° C.) | | | | | | | | | | |
| Min. Viscosity Temp. Range | | | | | | | | | | |
| (° C.) | | | | | | | | | | |
| Gelatinization Rate (cP/° C.) | | | | | | | | | | |
| Solubility Rate (cP/° C.) | | | | | | | | | | |
| Set-Back (cP/° C.) | | | | | | | | | | |
| Absolute Solubility (° C.) | | | | | | | | | | |
| Absolute Gelatinization (° C.) | | | | | | | | | | |
| Absolute Set-back (° C.) | | | | | | | | | | |
| Volume (mm) | | | | | | | | | | |
| Symmetry | | | | | | | | | | |
| Uniformity | | | | | | | | | | |
| Initial Hardness (g) | | | | | | | | | | |
| 24 Hour Hardness (g) | | | | | | | | | | |
| Initial Cohesiveness | 1.000 | | | | | | | | | |
| 24 Hour Cohesiveness | 0.944 | 1.000 | | | | | | | | |
| Initial Springiness | 0.394 | 0.422 | 1.000 | | | | | | | |
| 24 Hour Springiness | 0.788 | 0.774 | 0.590 | 1.000 | | | | | | |
| Initial Resilience | 0.962 | 0.925 | 0.410 | 0.720 | 1.000 | | | | | |
| 24 Hour Resilience | 0.930 | 0.983 | 0.400 | 0.741 | 0.950 | 1.000 | | | | |
| Initial Gumminess | 0.344 | 0.457 | 0.007 | 0.181 | 0.303 | 0.493 | 1.000 | | | |
| 24 Hour Gumminess | 0.591 | 0.606 | 0.077 | 0.265 | 0.663 | 0.671 | 0.859 | 1.000 | | |
| Initial Chewiness | 0.399 | 0.528 | 0.000 | 0.237 | 0.357 | 0.564 | 0.995 | 0.891 | 1.000 | |
| 24 Hour Chewiness | 0.663 | 0.676 | 0.115 | 0.343 | 0.729 | 0.738 | 0.840 | 0.993 | 0.883 | 1 |

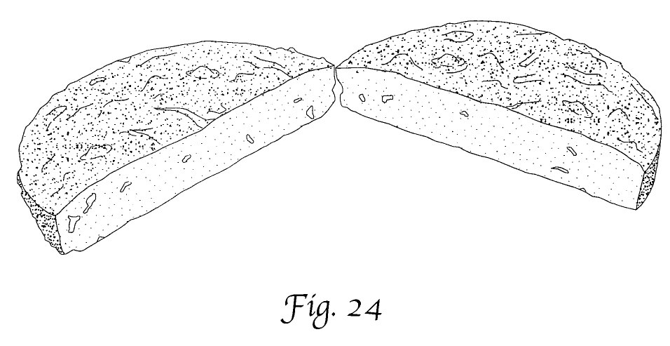

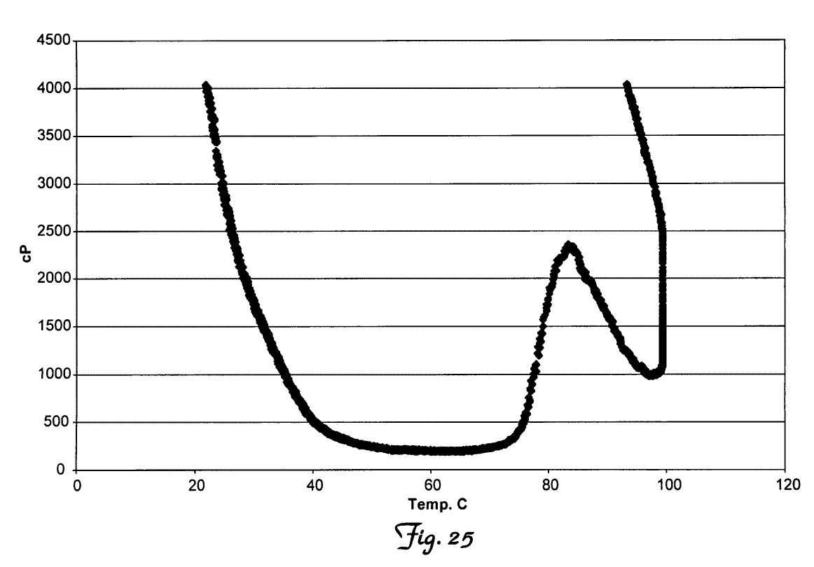

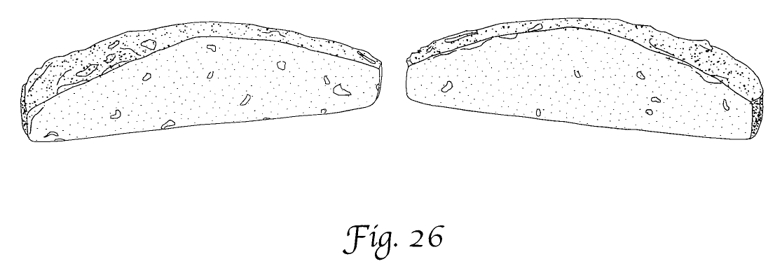

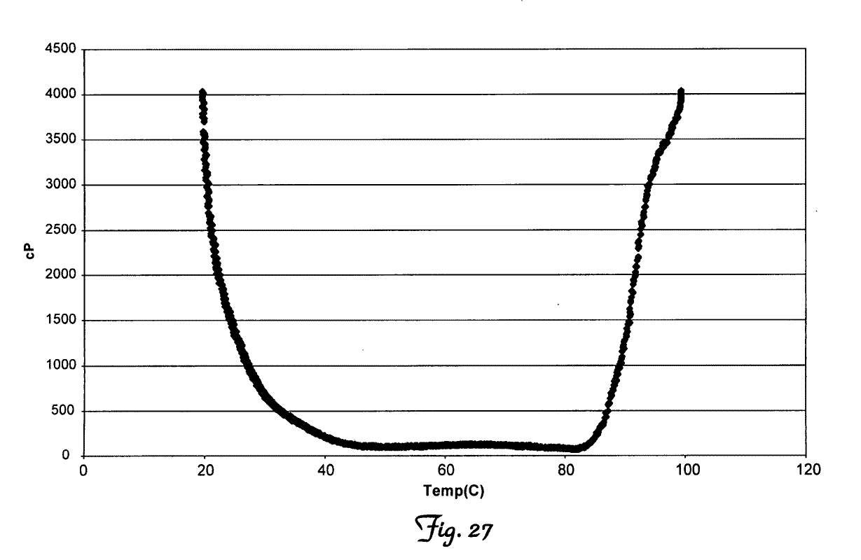

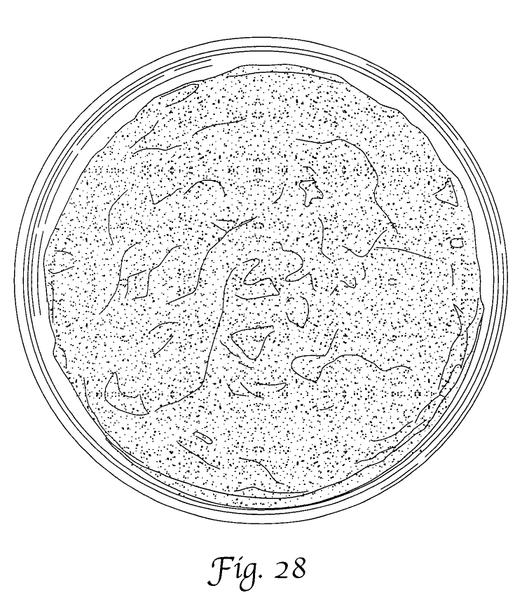

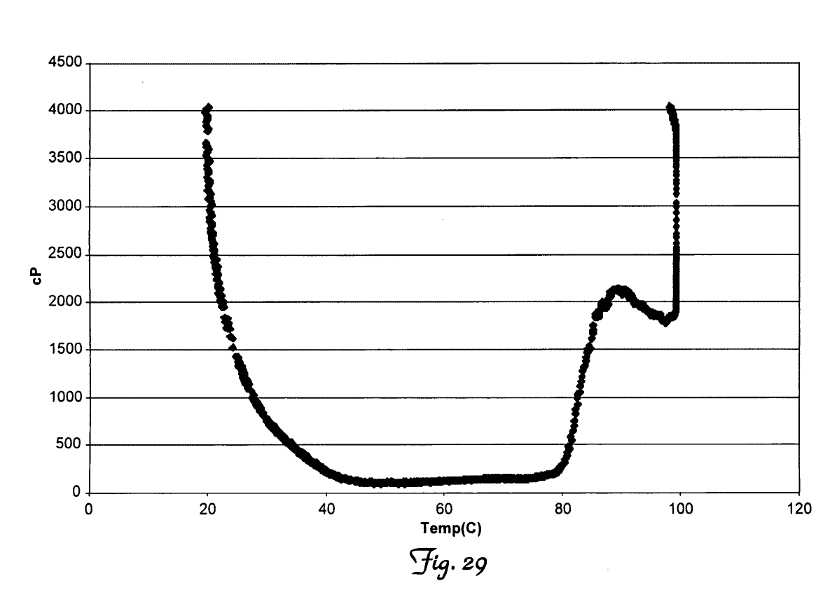

The results further indicate that certain ERO parameters are essential for the production of acceptable gluten-free cake. The specific ERO parameters that are essential for gluten-free cake are acceptable peak viscosity and 2^{nd} minimum viscosity. The absence of an acceptable peak viscosity and 2^{nd} minimum viscosity corresponds to unacceptable gluten-free cake. An example of an acceptable gluten-free cake is shown in FIG. 24, and its corresponding ERO profile is shown in FIG. 24. Examples of unacceptable gluten-free cakes and their ERO profiles are provided in FIG. 26-33. Acceptability was determined subjectively by observing the geometry of the produced cakes. If the cake collapsed (FIG. 25) or contained a high dome peak (FIG. 28), then they were considered unacceptable.

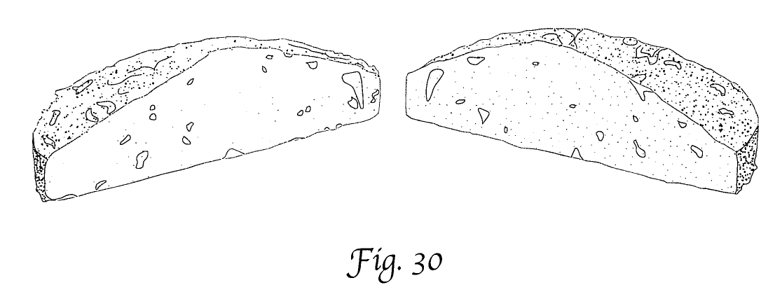

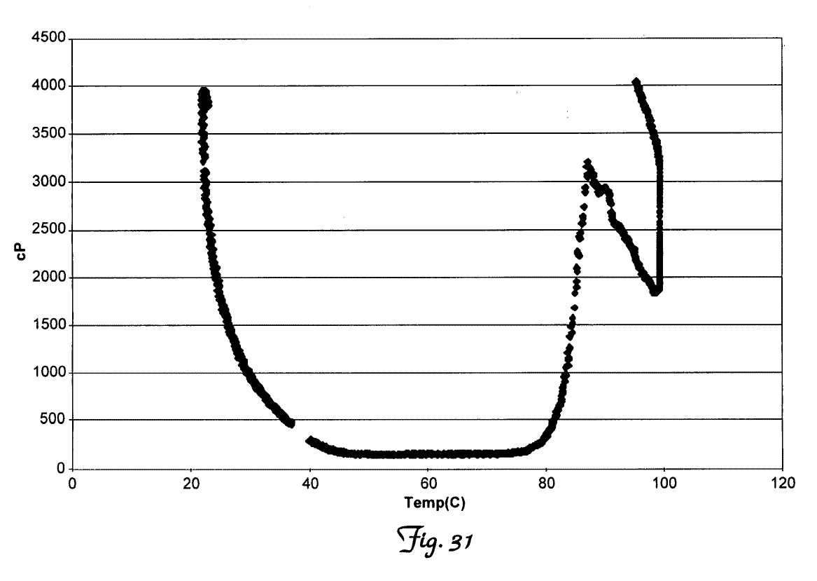

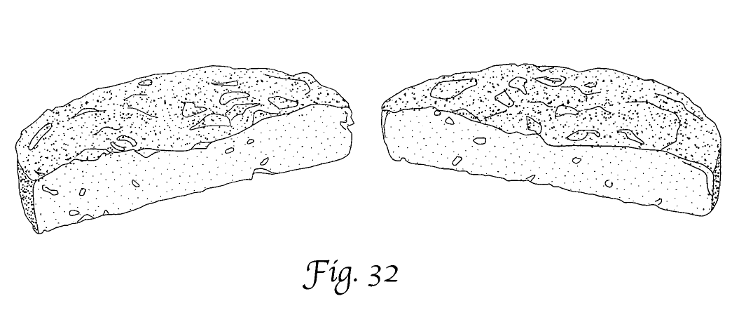

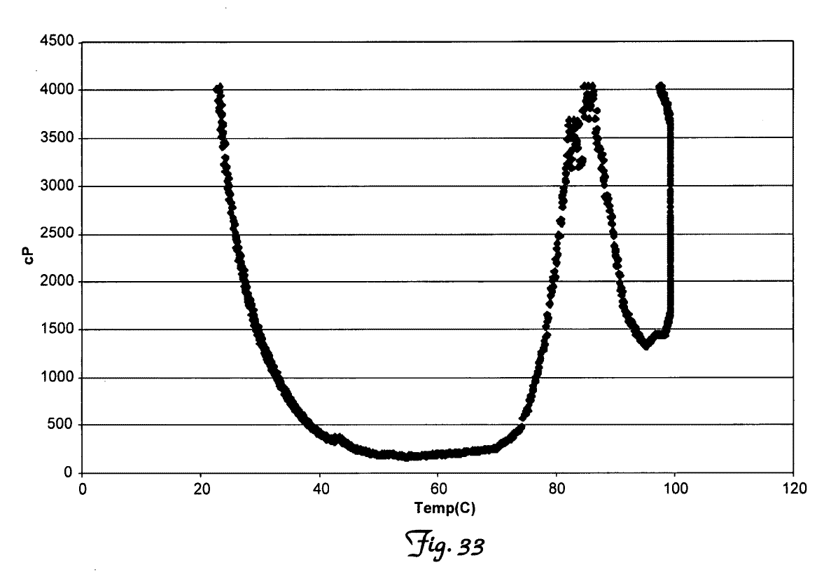

FIGS. 30-33 indicate that even if a gluten-free cake formulation produces an ERO curve that contains all the derived and essential parameters, an unacceptable cake can still be produced. FIGS. 31 and 33 are ERO profile that contain all the derived parameters but which correspond to unacceptable conventional cakes, FIGS. 30 and 32 respectively. Defining limitations (both minimum and maximum values) of ERO parameters further validate the usefulness of using an ERO for the formulation of gluten-free cakes.

By using the data from all the acceptable cakes produced from the factorial design of varied xanthan gum and liquid concentration with the three starches, minimum and maximum limits were obtained to define an ERO curve that produces an acceptable and high quality gluten-free cake. The minimum and maximum limits for each ERO parameter are shown in Table 9.

TABLE 9
Minimum and Maximum limits for each ERO parameter

| Parameter | Minimum | Maximum |
|---|---|---|
| Peak Viscosity (cP) | 34 | 4200 |
| 2nd Min. Viscosity (cP) | 33 | 4780 |
| Min. Viscosity (cP) | 33 | 263 |
| Min. Viscosity Range (° C.) | 14 | 60 |
| Temp. @ Min. Viscosity (° C.) | 24 | 96 |
| Temp. @ Peak Viscosity (° C.) | 77 | 101 |
| Temp. @ 2nd Min. Viscosity (° C.) | 90 | 105 |
| Absolute Solubility (° C.) | 37 | 41 |
| Absolute Gelatinization (° C.) | 67 | 91 |
| Absolute Set-back (° C.) | 103 | 129 |
| Set-back Rate (cP/° C.) | −340 | −20 |
| Gelatinization Rate (cP/° C.) | 130 | 570 |
| Solubility Rate (cP/° C.) | −240 | −60 |

ERO parameter ranges were derived using 99 percent confidence intervals of the lognormally distributed data points.

### EXAMPLE 5

A commercial cake mix (Pillsbury® Moist Supreme Classic White) was used to prepare a batter for ERO evaluation. Two cake mixes were used and 78 grams of dried eggs, 121 grams of oil and 584.2 grams of water were added. Ingredients were all added to a Hobart N-50 mixing bowl and mixed by hand with a spatula until all ingredients were moist. The mixture was then mixed on low speed for 2 minutes. A sample of batter made according to the formula and mixing procedure described above was baked in an ERO. The batter was heated, and its temperature and viscosity measured, for 59 minutes, starting at 21.2° C. and ending at 99.3° C.

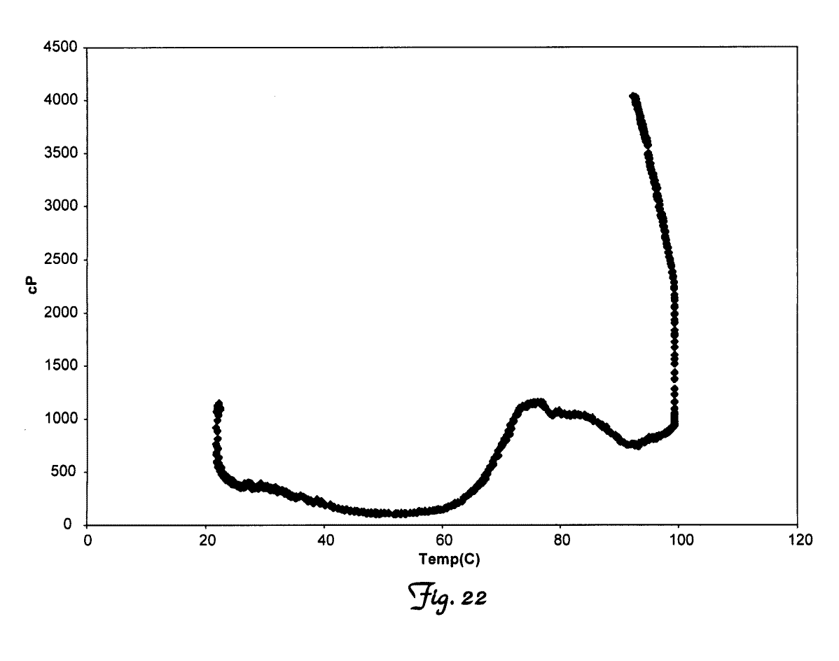

FIG. 22 shows the ERO curve of the viscosity of the batter versus temperature. This ERO curve was generated from data collected as the batter was heated in the ERO. The minimum viscosity of the ERO curve was 226 cP. This minimum viscosity occurred when the temperature of the batter was 64° C. An increase in viscosity occurred at a temperature of approximately 75° C. This increase in viscosity may correspond to starch gelatinization and/or denaturation of the egg albumin.

### EXAMPLE 6

A commercial gluten-free cake mix (Authentic Foods, vanilla cake mix) was used to prepare a batter for conventional oven and ERO evaluation. Three cake mixes were used and 295 grams of whole eggs, 165 grams of oil and 360 grams of milk were added. Ingredients were all added to a Hobart N-50 mixing bowl and mixed by hand with a spatula until all ingredients were moist. The mixture was then mixed on low speed for 1 minute then mixed on medium speed for 2 minutes. Samples of batter made according to the formula and mixing procedure described above were baked in a convention reel oven and an ERO. The batter baked in a conventional oven was baked at 375° F. for 30 minutes. The batter baked in an ERO was heated, and its temperature and viscosity measured, for 34 minutes, starting at 21.2° C. and ending at 99.3° C. It was subsequently cooled, and its temperature and viscosity measured, for 26 minutes to 80.0° C.

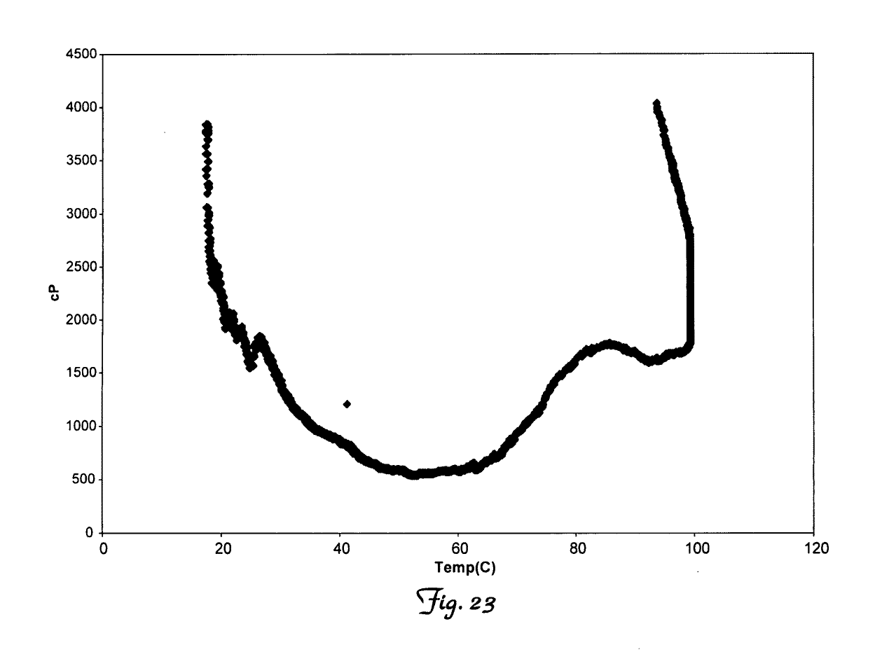

FIG. 23 shows the ERO curve of the viscosity of the batter versus temperature. This ERO curve was generated from data collected as the batter was heated and cooled in the ERO. The shape of the produced ERO curved appeared similar to other gluten-free ERO curves, however the ERO values were considerably different. The minimum viscosity (550 cP), solubility rate (−83.7 cP/° C.), absolute solubility (46.5° C.) and absolute gelatinization (52.4° C.) were all greater than any other ERO curve produced. The peak viscosity (1782 cP), temperature at second minimum (92° C.) and gelatinization rate (56.6 cP/° C.) were all less than any other ERO curved produced. The extreme ERO values corresponded to an unacceptable cake baked with a conventional oven. The internal structure contained large voids and the internal texture was very wet and gummy. The cake's geometry (determined as per AACC Method 10-91) was average with a volume of 128, symmetry of −8 and uniformity of 0.

As seen from the foregoing, the present invention is directed to the use of ERO heating and analysis to optimize and/or control batter characteristics in order to produce cakes and other products having properties comparable to those of conventional wheat flour-containing products. In addition to the optimization techniques described above, the present invention is also directed to products resulting from such optimization, and includes dry mixes, pre-mixes, batters, doughs, and finished products, any of which can be used or distributed at ambient, refrigerated, or frozen temperatures.

### EXAMPLE 7

A gluten free white cake was used to prepare a batter for conventional and ERO evaluations. The ingredients of this batter are listed in Table 10.

TABLE 10
Ingredients in a Gluten Free White Cake Batter

| | | |
|---|---|---|
| Ingredient | Total % | Grams |

Dry Mix Formula

| | | |
|---|---|---|
| Sugar, Regular | 43.64 | 1745.6 |
| Dextrose | 2.00 | 80.0 |
| Salt | 0.90 | 36.0 |
| Shortening, Cake & Icing | 12.00 | 480.0 |
| Panolite 50 SVK | 0.25 | 10.0 |
| Polysorbate 60 | 0.10 | 4.0 |
| Starch, Tapioca | 38.05 | 1522.0 |
| Xanthan Gum | 0.36 | 14.4 |
| Baking Soda | 0.75 | 30.0 |
| MCP, monohydrate, 12XX | 0.30 | 12.0 |
| SAPP 28 | 0.70 | 28.0 |
| SSL | 0.50 | 20.0 |
| Nat. B&V Flavor, Int. Bakers | 0.35 | 14.0 |
| CMC-7MF, Hercules | 0.10 | 4.0 |
| Total | 100.00 | 4000.0 |

Batter Formula

| | | |
|---|---|---|
| Dry Mix | 63.94 | 1259.0 |
| Egg Whites, Liguid/Frozen | 18.28 | 360.0 |
| Water 85° F. | 17.78 | 350.0 |
| Total | 100.00 | 1969.0 |

To make the dry mix, the sugar, salt, and shortening was first creamed by mixing for two minutes on setting 1 (low speed) in a Hobart A-120 mixer equipped with a mixing paddle. The rest of the dry ingredients were then added and mixed for 10 minutes on setting 1. The batter was made by first mixing the water and eggs together, and adding the dry mix and ½ the egg and water mixture to the mixing bowl of a Hobart N-50 mixer equipped with a mixing paddle, and mixing for one minute on setting 1 (low speed) and two minutes on setting 2 (medium speed). The remaining eggs and water were then added and mixed for one minute on setting 1 and two minutes on setting 2. The sides of the mixing bowl were then scarped and the batter was then mixed for another two minutes on setting 2). 397 grams was weighed into each of two 8-inch round cake pans and baked for 27 minutes at 350 degrees Fahrenheit.

The heights of the cakes were measured using the procedure discussed in Example 1. The measurements are provided in Table 11.

TABLE 11
Height Measurements of Gluten Free White Cake

| Cake | Point A | Point B | Point C | Point D | Point E |
|---|---|---|---|---|---|
| Measured | (in mm) | (in mm) | (in mm) | (in mm) | (in mm) |
| Cake 1 | 32 | 40 | 42 | 40 | 32 |
| Cake 2 | 32 | 40 | 42 | 40 | 32 |
| Average | 32 | 40 | 42 | 40 | 32 |

Volume, symmetry and uniformity indices of the cake were calculated using the equations described in Example 1. The values of the indices for the white cakes of this example are as follows:

Volume index=122

Symmetry index=4

Uniformity index=0

A samples of the batter made according to the formula in Table 10 was baked in an ERO. The batter was heated, and its temperature and viscosity measured for 32 minutes starting at 20.9° C. and ending at 99.3° C. It was subsequently cooled, and its temperature and viscosity measured for 13 minutes to 85.3° C.

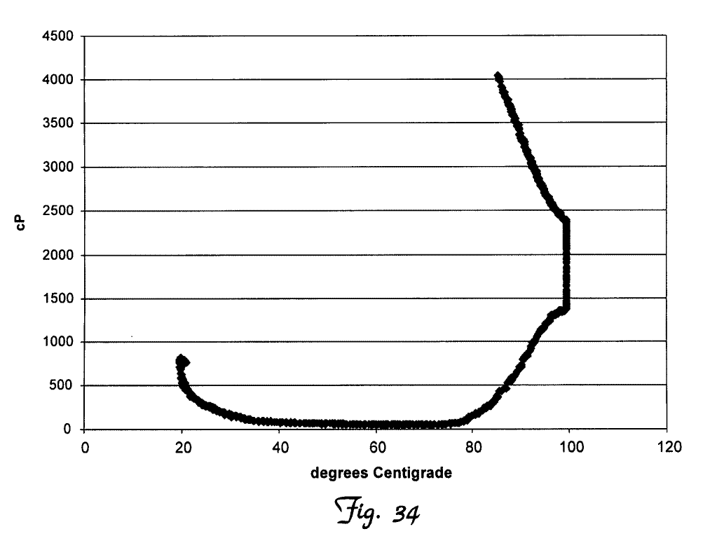

FIG. 34 shows the ERO curve of the viscosity of the batter versus temperature. This ERO curve was generated from data collected as the batter was heated and cooled in the ERO. The minimum viscosity of the ERO curve was 42.4 cP. This minimum viscosity occurred when the temperature of the batter was from 62.2° C. to 72.9° C. The temperature at the onset of the minimum of the curve was 40° C., while the temperature at the departure from the minimum of the curve was 75° C. After the batter reached a minimum viscosity, the viscosity increased, reaching a peak viscosity of 4038 cP at 85.3° C. This increase in viscosity may correspond to starch gelatinization and/or denaturation of the egg albumin.

When the ERO was shut off, the viscosity of the batter increased dramatically. The rate of the rise in viscosity as the batter cooled was 117.6 cP/° C., between about 99° C. and 85° C.

### EXAMPLE 8

A gluten free chocolate cake was used to prepare a batter for conventional and ERO evaluations. The ingredients of this batter are listed in Table 12.

TABLE 12
Ingredients in a Gluten Free Chocolate Cake Batter

| | | |
|---|---|---|
| Ingredient | Total % | Grams |

Dry Mix Formula

| | | |
|---|---|---|
| Sugar, Regular | 43.60 | 1744.0 |
| Dextrose | 2.00 | 80.0 |
| Salt | 0.90 | 36.0 |
| Shortening, Cake & Icing | 12.00 | 480.0 |
| Lecithin | 0.25 | 10.0 |
| Polysorbate 60 | 0.10 | 4.0 |
| Starch, Tapioca | 30.41 | 1216.4 |
| Cocoa, Russet Plus | 5.50 | 220.0 |
| Xanthan Gum | 0.36 | 14.4 |
| Soy Flour 200/70 | 2.51 | 100.4 |
| Baking Soda | 0.72 | 28.8 |
| MCP, monohydrate, 12XX | 0.24 | 9.6 |
| SAPP 28 | 0.56 | 22.4 |
| SSL | 0.50 | 20.0 |
| Nat. Vanilla Flavor | 0.25 | 10.0 |
| 073-00860 | | |
| CMC-7MF, Hercules | 0.10 | 4.0 |
| Total | 100.00 | 4000.0 |

Batter Formula

| | | |
|---|---|---|
| Dry Mix | 64.76 | 1259.0 |
| Whole Eggs, Liguid/Frozen | 18.52 | 360.0 |
| Water 85 F | 16.72 | 325.0 |
| Total | 100.00 | 1944.0 |

To make the dry mix, the sugar, salt, and shortening was first creamed by mixing for two minutes on setting 1 (low speed) in a Hobart A-120 mixer equipped with a mixing paddle. The rest of the dry ingredients were then added and mixed for 10 minutes on setting 1. The batter was made by first mixing the water and eggs together and adding the dry mix and V2 the egg and water mixture to the mixing bowl of a Hobart N-50 mixer equipped with a mixing paddle and mixing for one minute on setting 1 (low speed) and two minutes on setting 2 (medium speed). The remaining eggs and water were then added, and mixed for one minute on setting 1 and two minutes on setting 2. The sides of the mixing bowl were then scarped and the batter was then mixed for another two minutes on setting 2). 397 grams was weighed into each of two 8-inch round cake pans and baked for 27 minutes at 350 degrees Fahrenheit.

The heights of the cakes were measured using the procedure discussed in Example 1. The measurements are provided in Table 13.

TABLE 13
Height Measurements of Gluten Free Chocolate Cake

| Cake | Point A | Point B | Point C | Point D | Point E |
|---|---|---|---|---|---|
| Measured | (in mm) | (in mm) | (in mm) | (in mm) | (in mm) |
| Cake 1 | 28 | 40 | 42 | 38 | 26 |
| Cake 2 | 26 | 36 | 40 | 38 | 26 |
| Average | 27 | 38 | 41 | 38 | 26 |

Volume, symmetry and uniformity indices of the cake were calculated using the equations described in Example 1. The values of the indices for the chocolate cakes of this example are as follows:

Volume index=117

Symmetry index=6

Uniformity index =0

A sample of the batter made according to the formula in Table 12 was baked in an ERO. The batter was heated, and its temperature and viscosity measured for 21 minutes starting at 22.1° C. and ending at 99.3.° C. It was subsequently cooled, and its temperature and viscosity measured for 16 minutes to 84.0° C.

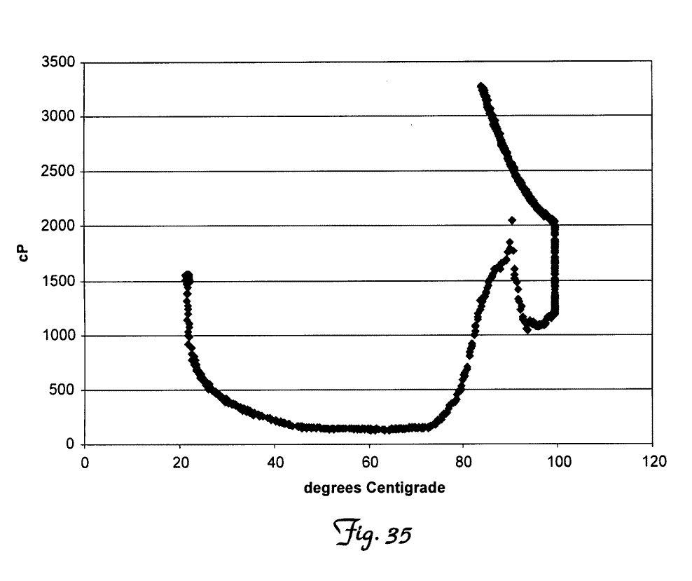

FIG. 35 shows the ERO curve of the viscosity of the batter versus temperature. This ERO curve was generated from data collected as the batter was heated and cooled in the ERO. The minimum viscosity of the ERO curve was 124.5 cP. This minimum viscosity occurred when the temperature of the batter was at 61.5° C. The temperature at the onset of the minimum of the curve was about 51° C., while the temperature at the departure from the minimum of the curve was about 71° C. After the batter reached a minimum viscosity, the viscosity increased, reaching a peak viscosity of 2051 cP at 90.4° C. This increase in viscosity may correspond to starch gelatinization and/or denaturation of the egg albumin.

The increase in viscosity was followed by a decrease in viscosity. The viscosity decreased to a second minimum of 1041 cP at 93.8° C. The cause of this decrease in viscosity is unclear, but could be related to the sugar going into solution. When the ERO was shut off, the viscosity of the batter increased dramatically. The rate of the rise in viscosity as the batter cooled was 82 cP/° C., between about 99° C. and 84° C.

### EXAMPLE 9

A gluten free yellow cake was used to prepare a batter for conventional and ERO evaluations. The ingredients of this batter are listed in Table 14.

TABLE 14
Ingredients in a Gluten Free Yellow Cake Batter

| | | |
|---|---|---|
| Ingredient | Total % | Grams |

Dry Mix Formula

| | | |
|---|---|---|
| Sugar, Regular | 44.00 | 1760.0 |
| Dextrose | 2.00 | 80.0 |
| Salt | 0.90 | 36.0 |
| Shortening, Cake & Icing | 12.00 | 480.0 |
| Polysorbate 60 | 0.10 | 4.0 |
| Starch, Tapioca | 35.71 | 1428.4 |
| Xanthan Gum | 0.36 | 14.4 |
| Soy Flour 200/70 | 2.51 | 100.4 |
| Baking Soda | 0.61 | 24.4 |
| MCP, monohydrate, 12XX | 0.25 | 10.0 |
| SAPP 28 | 0.56 | 22.4 |
| SSL | 0.50 | 20.0 |
| Natural Yellow Cake Fl., | 0.40 | 16.0 |
| Cargill | | |
| CMC-7MF, Hercules | 0.10 | 4.0 |
| Total | 100.00 | 4000.0 |

Batter Formula

| | | |
|---|---|---|
| Dry Mix | 62.34 | 1259.0 |
| Whole Eggs, | 18.28 | 360.0 |
| Liguid/Frozen | | |
| Water | 17.78 | 350.0 |
| | 100.00 | 1969.0 |

To make the dry mix the sugar, salt, and shortening was first creamed by mixing for two minutes on setting 1 (low speed) in a Hobart A-120 mixer equipped with a mixing paddle. The rest of the dry ingredients were then added and mixed for 10 minutes on setting 1. The batter was made by first mixing the water and eggs together and adding the dry mix and ½ the egg and water mixture to the mixing bowl of a Hobart N-50 mixer equipped with a mixing paddle and mixing for one minute on setting 1 (low speed) and 2 minutes on setting 2 (medium speed). The remaining eggs and water were then added and mixed for one minute on setting 1 and two minutes on setting 2. The sides of the mixing bowl were then scraped and the batter was then mixed for another 2 minutes on setting 2). 397 grams was weighed into each of two 8-inch round cake pans and baked for 27 minutes at 350 degrees Fahrenheit.

The heights of the cakes were measured using the procedure discussed in Example 1. The measurements are provided in Table 15.

TABLE 15
Height Measurements of Gluten Free Yellow Cake

| Cake | Point A | Point B | Point C | Point D | Point E |
|---|---|---|---|---|---|
| Measured | (in mm) | (in mm) | (in mm) | (in mm) | (in mm) |
| Cake 1 | 26 | 34 | | 36 | 24 |
| Cake 2 | 26 | 36 | 38 | 36 | 25 |
| Average | 26 | 35 | 40.5 | 36 | 24.5 |

Volume, symmetry and uniformity indices of the cake were calculated using the equations described in Example 1. The values of the indices for the white cakes of this example are as follows:

Volume index=111.5

Symmetry index=10

Uniformity index=−1

A sample of the batter made according to the formula in Table 15 was baked in an ERO. The batter was heated, and its temperature and viscosity measured for 20 minutes starting at 19.1° C. and ending at 99.3° C. It was subsequently cooled, and its temperature and viscosity measured for 18 minutes to 83.0° C.

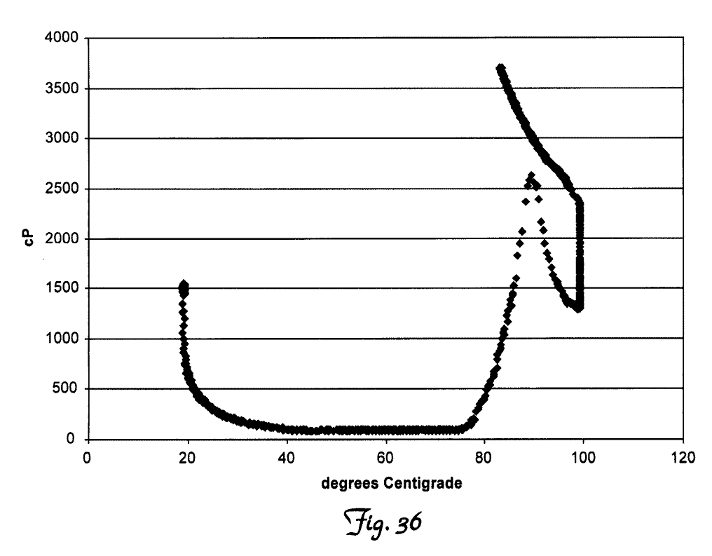

FIG. 36 shows the ERO curve of the viscosity of the batter versus temperature. This ERO curve was generated from data collected as the batter was heated and cooled in the ERO. The minimum viscosity of the ERO curve was 79.7 cP. This minimum viscosity occurred when the temperature of the batter was 45.8° C. The temperature at the onset of the minimum of the curve was 45° C., while the temperature at the departure from the minimum of the curve was 75° C. After the batter reached a minimum viscosity, the viscosity increased, reaching a peak viscosity of 2630 cP at 89.4° C. This increase in viscosity may correspond to starch gelatinization and/or denaturation of the egg albumin.

The increase in viscosity was followed by a decrease in viscosity. The viscosity decreased to a second minimum of 1287 cP at 98.8° C. The cause of this decrease in viscosity is unclear, but could be related to the sugar going into solution. When the ERO was shut off, the viscosity of the batter increased dramatically. The rate of the rise in viscosity as the batter cooled was 83 cP/° C., between about 99.3° C. and 83° C.

All publications, patents and patent applications are incorporated herein by reference. While in the foregoing specification this invention has been described in relation to certain preferred embodiments thereof, and many details have been set forth for purposes of illustration, it will be apparent to those skilled in the art that the invention is susceptible to additional embodiments and that certain of the details described herein may be varied considerably without departing from the basic principles of the invention.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An ingredient delivery system comprising a dry, gluten-free baking mix that when processed to form a batter and baked in an oven forms a bakery product that has a peak viscosity of 34 cP to 4200 cP, and a 2nd minimum viscosity of 34 cP to 4789 cP.

2. The ingredient delivery system of claim 1, wherein the oven is an electrical resistance oven (ERO).

3. The ingredient delivery system of claim 1, wherein the bakery product further has a minimum viscosity of 33 cP to 263 cP.

4. The ingredient delivery system of claim 1, wherein the bakery product further has a minimum viscosity of 14° C. to 60° C.

5. The ingredient delivery system of claim 1, wherein the bakery product further has a temperature at minimum viscosity of 24° C. to 96° C.

6. The ingredient delivery system of claim 1, wherein the bakery product further has a temperature at peak viscosity of 77° C. to 101° C.

7. The ingredient delivery system of claim 1, wherein the bakery product further has a temperature at second minimum viscosity of 90° C. to 105° C.

8. The ingredient delivery system of claim 1, wherein the bakery product further has an absolute solubility of 37° C. to 41° C.

9. The ingredient delivery system of claim 1, wherein the bakery product further has an absolute gelatinization of 67° C. to 91° C.

10. The ingredient delivery system of claim 1, wherein the bakery product further has an absolute set-back of 103° C. to 129° C.

11. The ingredient delivery system of claim 1, wherein the bakery product further has a set-back rate of −340 cP/° C. to −20 cP/° C.

12. The ingredient delivery system of claim 1, wherein the bakery product further has a gelatinization rate of 130 cP/° C. to 570 cP/° C.

13. The ingredient delivery system of claim 1, wherein the bakery product further has a solubility rate of −240 cP/° C. to −60 cP/° C.

14. The ingredient delivery system of claim 1, wherein the bakery product is a cake, muffin, pancake or waffle.

15. The ingredient delivery system of claim 1, wherein the bakery product is a cake.

16. The ingredient delivery system of claim 1, wherein the bakery product is wheat-free.

17. The ingredient delivery system if claim 1, wherein the bakery product is dairy-free.

18. A method of producing a gluten-free bakery product comprising processing an ingredient delivery system comprising a dry, gluten-free baking mix to form a batter and baking the batter in an oven to form a bakery product has a peak viscosity of 34 cP to 4200 cP, and a 2nd minimum viscosity of 34 cP to 4789 cP.

19. The method of claim 18, wherein the oven is an electrical resistance oven (ERO).

20. A gluten-free cake made by the method of claim 19.

21. A method of monitoring a bakery product's quality comprising baking a gluten-free batter in an electrical resistance oven (ERO), measuring the peak viscosity and 2^{nd} minimum viscosity of the bakery product to determine if the bakery product has a peak viscosity of 34 cP to 4200 cP, and a 2^{nd} minimum viscosity of 34 cP to 4780 cP.

22. A method for making a gluten-free product, comprising the steps of:
(a) combining gluten-free ingredients to make a gluten-free test batter;
(b) performing an electrical resistance evaluation of the gluten-free test batter comprising identification of an acceptable minimum viscosity;
(c) preparing a second gluten-free batter, wherein levels of the gluten-free ingredients are optimized based on the electrical resistance evaluation; and
(d) heating the second gluten-free batter to prepare the gluten-free product.

23. A product made by the method of claim 22.
